(19) United States
(12) Patent Application Publication
(10) Pub. No.: US 2014/0045966 A1
(43) Pub. Date: Feb. 13, 2014

(54) PHOTOSENSITIVE COMPOSITION. CURED ARTICLE, AND METHOD FOR PRODUCING ACTINICALLY CURED ARTICLE

(71) Applicants: Shihei Motofuji, Kyoto (JP); Shintaro Higuchi, Kyoto (JP); Hironobu Tokunaga, Kyoto (JP); Takao Mukai, Kyoto (JP); Takeshi Otaka, Kyoto (JP); Yusuke Mizuno, Kyoto (JP); Yasuhiro Shindo, Kyoto (JP); Eiji Matsumoto, Kyoto (JP)

(72) Inventors: Shihei Motofuji, Kyoto (JP); Shintaro Higuchi, Kyoto (JP); Hironobu Tokunaga, Kyoto (JP); Takao Mukai, Kyoto (JP); Takeshi Otaka, Kyoto (JP); Yusuke Mizuno, Kyoto (JP); Yasuhiro Shindo, Kyoto (JP); Eiji Matsumoto, Kyoto (JP)

(21) Appl. No.: 14/002,219

(22) PCT Filed: Mar. 6, 2012
(86) PCT No.: PCT/JP2012/055634

§ 371 Date: Oct. 28, 2013

(30) Foreign Application Priority Data
Mar. 7, 2011 (JP) 2011-049470
Apr. 28, 2011 (JP) 2011-101435
Jul. 11, 2011 (JP) 2011-153236
Aug. 12, 2011 (JP) 2011-176838
Sep. 6, 2011 (JP) 2011-194210

(51) Int. Cl. C08F 22/10

(52) U.S. Cl. CPC C08F 22/105
USPC 522/183; 526/320

(57) ABSTRACT

The photosensitive composition of the present invention includes: (1) a radical initiator (A); (2) an acid generator (B) and/or a base generator (C); and (3) a polymerizable substance (D), wherein at least one of the radical initiator (A), the acid generator (B) and the base generator (C) are to generate an active species (H) on exposure to active rays, the active species (H) reacting with the radical initiator (A), the acid generator (B) or the base generator (C) to generate another active species (I), the active species (I) initiating polymerization of the polymerizable substance (D), the active species (H) or (I) is an acid or a base, and the photosensitive composition contains substantially no colorants, metal oxide powder, or metallic powder.

### TECHNICAL FIELD

The present invention relates to a photosensitive composition that is cured by exposure to light to form a transparent cured article.

So-called “UV coating”, which is a surface coating treatment involving curing by exposure to light, has been widening its application to coating materials, adhesive agents, and the like, because of its efficiency (quick curing performance) and VOC reduction performance.

Common photocurable coating materials and photocurable adhesive agents contain photopolymerization initiators and radical polymerizable monomers, oligomers or polymers, and optionally contain various additives according to their intended use.

In radical polymerization in production of photocurable coating agents, oxygen inhibits curing of the agents to lower the curability near the surface, resulting in insufficient hardness and scratch resistance. To solve this problem, use of specific inorganic particles has been proposed (e.g. Patent Literature 1).

The photocurable coating agent of the invention of Patent Literature 1, containing inorganic particles with a specific structure, achieves sufficient hardness and scratch resistance. This coating agent, however, causes insufficient adhesion to substrates and deteriorated transparency which results in a problem when used for transparent cured articles such as transparent coating films.

As for another application, adhesive agents are proposed to be used as adhesive filling agents to fill a gap between an image display unit and a front panel of a flat panel display (FPD) such as a liquid crystal display (LCD) and plasma display (PDP), thereby improving the contrast and brightness of the FPD (e.g. Patent Literature 2). However, no photocurable adhesive filling agents have been succeeded in achieving required high heat resistance, adhesion to various substrates, and high transparency.

### CITATION LIST

### Patent Literature

Patent Literature 1: JP 2011-076002 A
Patent Literature 2: JP 2009-186957 A

### SUMMARY OF INVENTION

### Technical Problem

The present invention was made in view of the above problems and aims to provide a photosensitive composition that has excellent adhesion to various substrates and forms transparent cured articles (e.g. coating films).

The present invention also aims to provide a photosensitive composition enabling production of a photocurable coating agent excellent in hardness and scratch resistance.

The present invention still further aims to provide a photosensitive composition enabling production of a photocurable adhesive agent excellent in heat resistance.

### Solution to Problem

The present inventors intensively studied to achieve the above objects and developed the present invention. Specifically, the following four aspects of the invention are provided:

(I) A photosensitive composition, including the following the (1), (2), and (3) components: (1) a radical initiator (A); (2) an acid generator (B) and/or a base generator (C); and (3) a polymerizable substance (D), wherein at least one of the radical initiator (A), the acid generator (B), and the base generator (C) are to generate an active species (H) on exposure to active rays, the active species (H) reacting with the radical initiator (A), the acid generator (B), or the base generator (C) to generate another active species (I), the active species (I) initiating polymerization of the polymerizable substance (D), the active species (H) or (I) is an acid or a base, and the photosensitive composition contains substantially no colorants, metal oxide powder, or metallic powder.

(II) A photosensitive composition, including a polymerizable substance (D), and a radical initiator (A), an acid generator (B), and a base generator (C) in any one of the following combinations (1) to (4), wherein the photosensitive composition contains substantially no colorants, metal oxide powder, or metallic powder, the combinations being:

(1) a radical initiator (A1) that generates radicals on exposure to active rays; and at least one of an acid generator (B2) and a base generator (C2), the acid generator (B2) generating an acid on exposure to at least one species selected from the group consisting of radicals, acids, and bases, and the base generator (C2) generating a base on exposure to at least one species selected from the group consisting of radicals, acids, and bases;

(2) an acid generator (B1) that generates an acid on exposure to active rays; and a radical initiator (A2) that generates radicals on exposure to an acid and/or a base; and optionally a base generator (C2) that generates a base on exposure to at least one species selected from the group consisting of radicals, acids, and bases;

(3) a base generator (C1) that generates a base on exposure to active rays; and the radical initiator (A2) that generates radicals on exposure to an acid and/or a base; and optionally an acid generator (B2) that generates an acid on exposure to at least one species selected from the group consisting of radicals, acids, and bases; and

(4) a combination of two or more of the above (1) to (3).

(III) A cured article obtainable by curing the photosensitive composition according to any one of the above (I) or (II) on exposure to active rays.

(IV) A method for producing a cured article which is cured on exposure to active rays, including the steps of: polymerizing a polymerizable substance (D) on exposure to active rays in the presence of a radical initiator (A) and at least one of an acid generator (B) and base generator (C) but in the substantial absence of colorants, metal oxide powder and metallic powder, wherein at least one of the radical initiator (A), acid generator (B), and base generator (C) generates an active species (H) on exposure to active rays, the active species (H) reacts with the radical initiator (A), acid generator (B), or base generator (C) to generate another active species (I), the active species (I) initiates polymerization of the polymerizable substance (D), wherein the active species (H) or (I) is an acid or a base.

The term “active rays” herein refers to rays in the wavelength range of 360 to 830 nm.

### Advantageous Effects of Invention

The following are the effects of the photosensitive composition of the present invention or the cured article of the present invention:

(1) The cured article of the present invention, which is produced by curing the composition of the present invention, provides high adhesion to various substrates.

(2) The cured article of the present invention, which is produced by curing the composition of the present invention, provides high transparency.

(3) The photosensitive composition of the present invention provides good curability on exposure to active rays.

In addition to these effects achieved by all aspects of the present invention, the following effects can also be achieved:

(4) The cured article of the present invention, which is produced by curing the composition of the present invention, provides high hardness by using an appropriate polymerizable substance.

(5) The cured article of the present invention, which is produced by curing the composition of the present invention, provides high scratch resistance by using an appropriate polymerizable substance.

(6) The cured article of the present invention, which is produced by curing the composition of the present invention, provides high heat resistance by using an appropriate polymerizable substance.

### DESCRIPTION OF EMBODIMENTS

The photosensitive composition of the present invention contains:

(1) a radical initiator (A);

(2) an acid generator (B) and/or a base generator (C); and

(3) a polymerizable substance (D).

In the photosensitive composition of the present invention and the method for producing a cured article of the present invention, which is cured on exposure to active rays, at least one of the radical initiator (A), the acid generator (B), and the base generator (C) are to generate an active species (H) on exposure to active rays. The active species (H) reacts with the radical initiator (A), the acid generator (B), or the base generator (C) to generate another active species (I), and the active species (I) initiates polymerization of the polymerizable substance (D) to be polymerized. Examples of the active species (H) and (I) include radicals, acids, bases, and the like. However, either the active species (H) or (I) generated in the above reactions should be an acid or a base. Diffusion of the active species (H) enables curing in narrow gaps such as a gap between an image display unit and a front panel of a FPD, whereas a typical photopolymerization initiator has difficulty in photocuring in such narrow gaps. In addition, the transparency and adhesion to substrates of the resulting cured article are also improved. These characteristics are presumably achieved due to the uniform curing of the composition of the present invention. For easier diffusion of the active species (H), a polymerizable substance (D) nonreactive with the active species (H) is preferably used.

In the case of cationic polymerization with the use of a single common acid generator or anionic polymerization with the use of a single common base generator, it is difficult to make use of light of wavelengths outside the absorption range of the generator. In the present invention, however, the use of light of wavelengths outside the absorption range of an acid generator or a base generator is enabled by using a radical initiator that can absorb light of wavelengths outside the absorption range together.

In the present invention, the radical initiator (A) refers to a compound that generates radicals on exposure to at least one of active rays, acids, and bases, and may be a known compound such as a radical initiator (A1) that generates radicals on exposure to active rays and a radical initiator (A2) that generates radicals on exposure to an acid and/or a base.

For example, acylphosphine oxide derivative-based polymerization initiators (A121), α-aminoacetophenone derivative-based polymerization initiators (A122), benzyl ketal derivative-based polymerization initiators (A123), α-hydroxyacetophenone derivative-based polymerization initiators (A124), benzoin derivative-based polymerization initiators (A125), oxime ester derivative-based polymerization initiators (A126), and titanocene derivative-based polymerization initiators (A127) all generate radicals on exposure to any of active rays, acids, and bases, and therefore any of these can be used as both (A1) and (A2).

Organic peroxide-based polymerization initiators (A21), azo-based polymerization initiators (A22), other radical initiators (A23), and the like all generate radicals on exposure to an acid and/or a base.

(A) may be a single compound or may be a combination of two or more compounds.

(A121) indicates that this compound is the first example of initiators (A12) that can be used as both (A1) and (A2).

Examples of the acylphosphine oxide derivative-based polymerization initiators (A121) include 2,4,6-trimethylbenzoyl-diphenylphosphine oxide [product of BASF (LUCIRIN TPO)] and bis(2,4,6-trimethylbenzoyl)-phenylphosphine oxide [product of BASF (IRGACURE 819)].

Examples of the α-aminoacetophenone derivative-based polymerization initiators (A122) include 2-methyl-1-(4-methylthiophenyl)-2-morpholinopropane-1-on [product of BASF (IRGACURE 907)], 2-benzyl-2-dimethylamino-1-(4-morpholinophenyl)butanone [product of BASF (IRGACURE 369)], and 1,2-(dimethylamino)-2-[(4-methylphenyl)methyl]-1-[4-(4-morpholinyl)phenyl]-1-butanone [product of BASF (IRGACURE 379)].

Examples of the benzyl ketal derivative-based polymerization initiators (A123) include 2,2-dimethoxy-1,2-diphenylethane-1-on [product of BASF (IRGACURE 651)].

Examples of the α-hydroxyacetophenone derivative-based polymerization initiators (A124) include 1-hydroxy-cyclohexyl-phenyl-ketone [product of BASF (IRGACURE 184)], 2-hydroxy-2-methyl-1-phenyl-propane-1-on [product of BASF (DAROCUR 1173)], 1-[4-(2-hydroxyethoxy)-phenyl]-2-hydroxy-2-methyl-1-propane-1-on [product of BASF (IRGACURE 2959)], and 2-hydroxy-1-{4-[4-(2-hydroxy-2-methyl-propionyl)-benzyl]phen yl}-2-methyl-propane-1-on [product of BASF (IRGACURE 127)].

Examples of the benzoin derivative-based polymerization initiators (A125) include benzoin methyl ether, benzoin ethyl ether, and benzoin isopropyl ether.

Examples of the oxime ester derivative-based polymerization initiators (A126) include 1,2-octanedione-1-[(4-(phenylthio)-2-(O-benzoyloxime)] [product of BASF (IRGACURE OXE 01)] and ethanone-1-(9-ethyl-6-(2-methylbenzoyl)-9H-carbazole-3-yl]-1-(0-acetyloxime) [product of BASF (IRGACURE OXE 02)].

Examples of the titanocene derivative-based polymerization initiators (A127) include bis(η5-2,4-cyclopentadiene-1-yl)-bis(2,6-difluoro-3-(1H-pyrrole-1-yl)-phenyl)titanium [product of BASF (IRGACURE 784)].

Examples of the organic peroxide-based polymerization initiators (A21) include benzoyl peroxide (BPO), t-butyl peroxyacetate, 2,2-di-(t-butylperoxy)butane, t-butyl peroxybenzoate, n-butyl 4,4-di(t-butylperoxy)valerate, di(2-t-butyl peroxyisopropyl)benzene, dicumylperoxide, di-t-hexylperoxide, 2,5-dimethyl-2,5-di(t-butylperoxy)hexane, t-butylcumyl peroxide, di-t-butyl peroxide, diisopropylbenzene hydroperoxide, p-menthane hydroperoxide, 1,1,3,3-tetramethylbutyl hydroperoxide, cumen hydroperoxide, t-butyl hydroperoxide, and t-butyl trimethylsilyl peroxide.

Examples of the azo-based polymerization initiators (A22) include 1-[(1-cyano-1-methylethyl)azo]formamide, 2,2′-azobis(N-butyl-2-methylpropionamide), 2,2′-azobis(N-cyclohexyl-2-methylpropionamide), and 2,2′-azobis(2,4,4-trimethylpentane).

Examples of other polymerization initiators (A23) include 2,3-dimethyl-2,3-diphenylbutane.

Preferred examples of the radical initiator (A2) that generates radicals on exposure to an acid and/or a base include the organic peroxide-based polymerization initiators (A21) and/or azo-based polymerization initiators (A22).

Preferable among these radical initiators (A) are the ones other than the organic peroxide-based polymerization initiators (A21) and azo-based polymerization initiators (A22), both of which generate radicals on exposure to heat as well, namely, radical initiators (A1) [including (A12)] that generate radicals on exposure to active rays are preferred in terms of the storage stability of the photosensitive composition. In particular, if the photosensitive composition contains the base generator (C1) that generates a base on exposure to active rays, (A12) is preferred because (A12) further promotes generation of radicals on exposure to the base generated by the (C1).

In terms of the photocurability, the amount of the radical polymerization initiator (A) in the photosensitive composition of the present invention is preferably 0.05 to 30% by weight, and more preferably 0.1 to 20% by weight, based on the weight of the polymerizable substance (D).

In the present invention, the acid generator (B) refers to a compound that generates an acid on exposure to at least one species selected from the group consisting of active rays, radicals, acids, and bases, and examples thereof include known compounds such as acid generators (B1) that generate an acid on exposure to active rays and acid generators (B2) that generate an acid on exposure to at least one species selected from the group consisting of radicals, acids, and bases.

A photosensitive composition including the acid generator (B) can have high sensitivity and avoid macroscopic reaction rate distribution. This presumably enables the cured article of the present invention, which is produced by curing the photosensitive composition of the present invention, to achieve high hardness, high scratch resistance, and high transparency.

For example, sulfonium salt derivatives (B121) and iodonium salt derivatives (B122) both generate an acid on exposure to either active rays or radicals, and therefore any of these can be used as both (B1) and (B2).

Sulfonic acid ester derivatives (B21), acetic acid ester derivatives (B22), phosphonic acid esters (B23), and the like all generate an acid on exposure to an acid and/or a base, and therefore any of these can be used as (B2).

(B) may be a single compound or a combination of two or more compounds.

(B121) indicates that this compound is the first example of initiators (B12) that can be used as both (B1) and (B2).

Examples of the sulfonium salt derivatives (B121) of the present invention include compounds represented by the following formula (1) or (2).

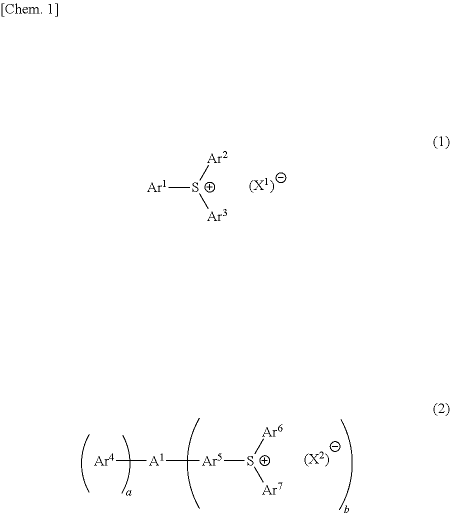

In the formulas (1) and (2), A¹ is a divalent or trivalent group represented by any one of the following formulas (3) to (10); Ar¹ to Ar⁷ are individually an aromatic hydrocarbon or heterocyclic group with at least one benzene ring, and are optionally substituted by at least one atom or substituent selected from the group consisting of halogens, and C1-C20 acyl, C1-C20 alkyl, C1-C20 alkoxy, C1-C20 alkylthio, C1-C20 alkylsilyl, nitro, carboxyl, hydroxyl, mercapto, amino, cyano, phenyl, naphthyl, phenoxy, and phenylthio groups; Ar¹ to Ar⁴, Ar⁶, and Ar⁷ are each a monovalent group, and Ar⁵ is a divalent group; (X¹)⁻ and (X²)⁻ are each a negative ion; and a is an integer of 0 to 2, b is an integer of 1 to 3, and (a+b) is 2 or 3 and is the same as the valence of A¹.

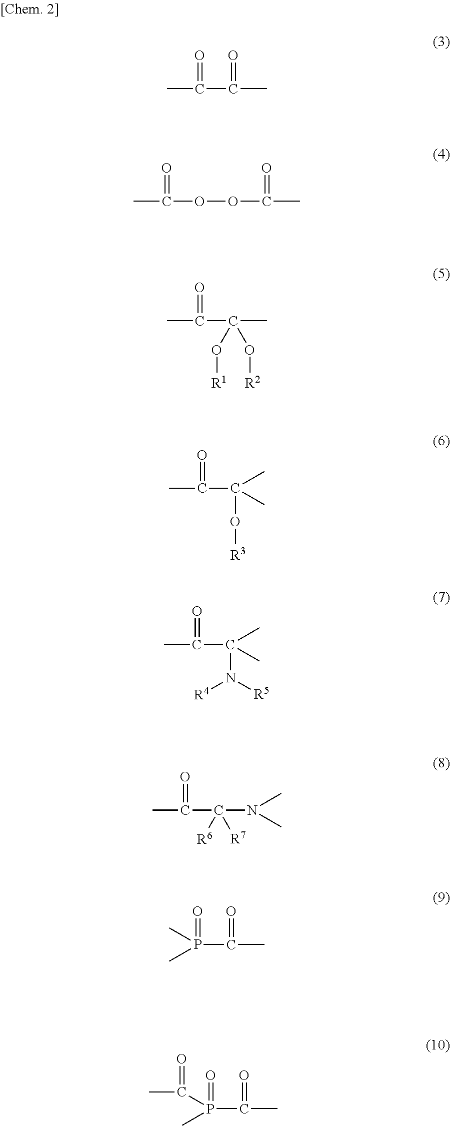

R¹ to R⁷ in the formulas (5) to (8) are individually a hydrogen, a C1-C20 alkyl group, or a phenyl group optionally substituted by at least one atom or substituent selected from the group consisting of halogens, and C1-C20 acyl, C1-C20 alkyl, amino, cyano, phenyl, naphthyl, phenoxy, and phenylthio groups; and R¹, R⁴, and R⁶ may optionally link to R², R⁵, and R⁷, respectively, to form a ring structure.

In terms of the efficiency of acid generation, A¹ in the formula (2) is preferably a group represented by any one of the formulas (5) and (7) to (10), and more preferably a group represented by any one of the formulas (5) and (8) to (10).

Ar¹ to Ar⁷ in the formulas (1) and (2) are groups that enable the compound represented by the formula (1) or (2) to absorb light of wavelengths within the ultraviolet to visible range.

Ar¹ to Ar⁷ preferably contain 1 to 5 benzene rings and more preferably 1 to 4 benzene rings.

Examples of ones containing one benzene ring include residues of benzene and heterocyclic compounds in which one or two hydrogen atoms are removed. Specific examples of the heterocyclic compounds include benzofran, benzothiophene, indore, quinoline, and coumarin.

Examples of ones containing two benzene rings include residues of naphthalene, biphenyl, fluorene, and heterocyclic compounds in which one or two hydrogen atoms are removed. Specific examples of the heterocyclic compounds include dibenzofuran, dibenzothiophene, xanthone, xanthene, thioxanthone, acridine, phenothiazine, and thianthrene.

Examples of ones containing three benzene rings include residues of anthracene, phenanthrene, terphenyl, and heterocyclic compounds in which one or two hydrogen atoms are removed. Specific examples of the heterocyclic compounds include p-(thioxanthylmercapto)benzene and naphthobenzothiophene.

Examples of ones containing four benzene rings include naphthacene, pyrene, benzoanthracene, and triphenylene residues in which one or two hydrogen atoms are removed.

Examples of halogens include fluorine, chlorine, bromine, and iodine. Fluorine and chlorine are preferred.

Examples of C1-C20 acyl groups include formyl, acetyl, propionyl, isobutyryl, valeryl, and cyclohexyl carbonyl groups.

Examples of C1-C20 alkyl groups include methyl, ethyl, n- or iso-propyl, n-, sec- or tert-butyl, n-, iso- or neo-pentyl, hexyl, heptyl, and octyl groups.

Examples of C1-C20 alkoxy groups include methoxy, ethoxy, n- or iso-propoxy, n-, sec- or tert-butoxy, n-, iso- or neo-pentyloxy, hexyloxy, heptyloxy, and octyloxy groups.

Examples of C1-C20 alkylthio groups include methylthio, ethylthio, n- or iso-propylthio, n-, sec- or tert-butylthio, n-, iso- or neo-pentylthio, hexylthio, heptylthio, and octylthio groups.

Examples of C1-C20 alkylsilyl groups include trialkylsilyl groups such as trimethylsilyl and triisopropylsilyl groups. The alkyl chains of these groups may be straight or branched.

Examples of substituent atoms and groups for substitution of Ar¹ to Ar⁷ include halogens, and cyano, phenyl, naphthyl, phenoxy, phenylthio, C1-C20 alkyl, C1-20 alkoxy, C1-C20 alkylthio, and C1-C20 acyl groups. These are preferred in terms of the efficiency of acid generation. Cyano, phenyl, C1-C15 alkyl, C1-C15 alkoxy, C1-C15 alkylthio, and C1-C15 acyl groups are more preferred, and C1-C10 alkyl, C1-C10 alkoxy, C1-C10 alkylthio, and C1-C10 acyl groups are particularly preferred. The alkyl chains of these groups may be straight, branched, or cyclic.

Preferably, Ar¹ to Ar⁴, Ar⁶ and Ar⁷ are individually a phenyl, p-methylphenyl, p-methoxyphenyl, p-tert-butylphenyl, 2,4,6-trimethylphenyl, p-(thioxanthylmercapto)phenyl, or m-chlorophenyl group in terms of the efficiency of acid generation.

In terms of the efficiency of acid generation, Ar⁵ is preferably a phenylene, 2- or 3-methylphenylene, 2- or 3-methoxyphenylene, 2- or 3-butylphenylene, or 2- or 3-chlorophenylene group.

Examples of negative ions for (X¹)⁻ and (X²)⁻ in the formulas (1) and (2) include halide anions; hydroxide anions; thiocyanate anions; C1-C4 dialkyldithio carbamate anions; carbonate anions; bicarbonate anions; aliphatic or aromatic carboxyl anions (e.g. benzoic acid anion, trifluoroacetic acid anion, perfluoroalkyl acetate anions, phenylglyoxylic acid anion) which are optionally substituted by halogen(s); aliphatic or aromatic sulfoxy anions (e.g. trifluoromethanesulfonic acid anion) which are optionally substituted by halogen(s); hexafluoro antimonate anion (SbF₆⁻); phosphorus anions [e.g. hexafluoro phosphorus anion (PF₆⁻), trifluoro tris(perfluoroethyl)phosphorus anion (PF₃(C₂F₅)₃⁻)]; and borate anions (e.g. tetraphenyl borate anion, butyltriphenyl borate anion). In terms of the efficiency of acid generation, phosphine anions, aliphatic sulfoxy anions substituted by halogen(s), and borate anions are preferred.

Examples of the sulfonium salt derivatives (B121) include compounds having a cationic structure such as a triphenylsulfonium cation structure, a tri-p-tolylsulfonium cation structure, and a [p-(phenylmercapto)phenyl]diphenyl sulfonium cation structure; and compounds represented by the formulas (11) to (14). They are preferred in terms of the efficiency of acid generation. Compounds represented by the following formulas (11) to (14) are more preferred.

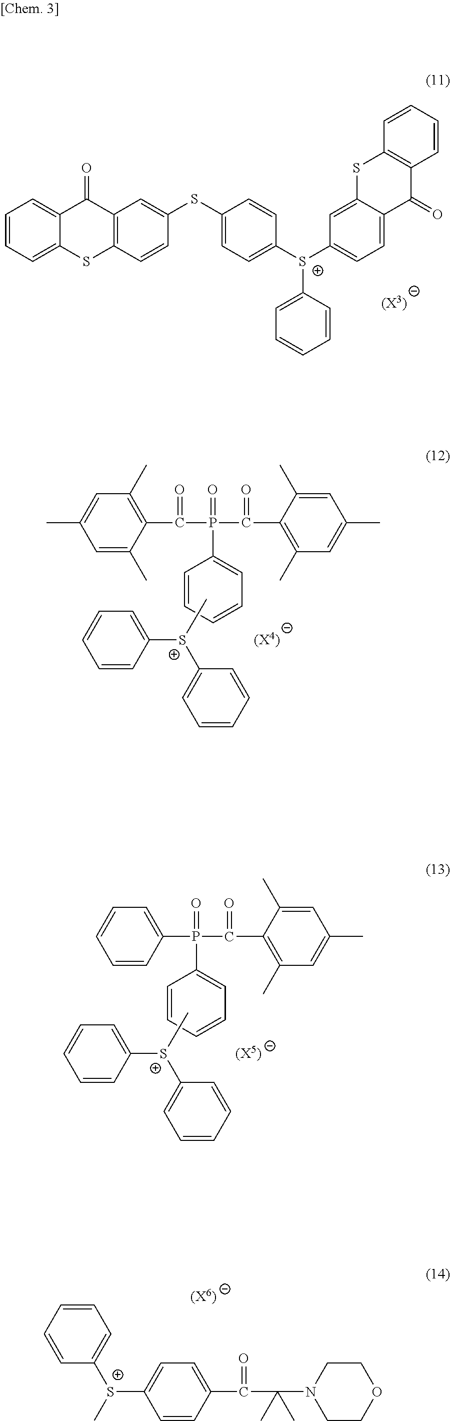

(X³)⁻ to (X⁶)⁻ in the formulas (11) to (14) are each a negative ion, and specific examples and preferred examples thereof are those listed above for (X¹)⁻ and (X²)⁻ in the formulas (1) and (2).

Examples of the iodonium salt derivatives (B122) in the present invention include those represented by the following formulas (15) and (16).

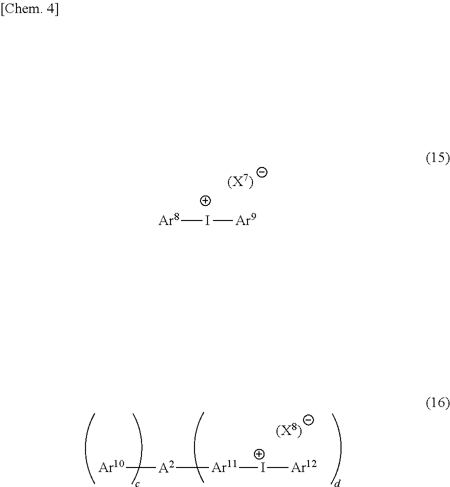

In the formulas, A² is a divalent or trivalent group represented by any one of the above formulas (3) to (10); Ar⁸ to Ar¹² are individually an aromatic hydrocarbon or heterocyclic group with at least one benzene ring, and are optionally substituted by at least one substituent selected from the group consisting of halogens, and C1-C20 acyl, C1-C20 alkyl, C1-C20 alkoxy, C1-C20 alkylthio, C1-C20 alkylsilyl, nitro, carboxyl, hydroxyl, mercapto, amino, cyano, phenyl, naphthyl, phenoxy, and phenylthio groups; Ar⁸ to Ar¹⁰, and Ar¹² are each a monovalent group, and Ar¹¹ is a divalent group; (X⁷)⁻ and (X⁸)⁻ are each a negative ion; and c is an integer of 0 to 2, d is an integer of 1 to 3, and (c+d) is 2 or 3 and is the same as the valence of A².

Examples of halogens, and C1-C20 acyl, C1-C20 alkyl, C1-C20 alkoxy, C1-C20 alkylthio, and C1-C20 alkylsilyl groups include those listed above for the formulas (1) and (2).

In terms of the efficiency of acid generation, A² in the formula (16) is preferably a group represented by any one of the above formulas (5) and (7) to (10), and more preferably a group represented by any one of the formulas (5) and (8) to (10).

Ar⁸ to Ar¹² in the formulas (15) and (16) are groups that enable the compound represented by the formula (15) or (16) to absorb light of wavelengths within the ultraviolet to visible range.

Ar⁸ to Ar¹² preferably contain 1 to 5 benzene rings and more preferably 1 to 4 benzene rings. Specific examples and preferred examples of Ar⁸ to Ar¹² are those listed for Ar¹ to Ar⁷ in the formulas (1) and (2).

Examples and preferred examples of (X⁷)⁻ and (X⁸)⁻ are those listed above for (X¹)⁻ and (X²)⁻ in the formulas (1) and (2)

Examples of the iodonium salt derivatives (B122) include compounds having a cationic structure such as a (4-methylphenyl){4-(2-methylpropyl)phenyl}iodonium cation structure, a [bis(4-t-butylphenyl)]iodonium cation structure, a [bis(4-t-butylphenyl)]trifluoro[tris(perfluoroethyl)]iodonium cation structure, a [bis(4-methoxyphenyl)]iodonium cation structure, and a [bis(4-methoxyphenyl)]iodonium cation structure; and compounds represented by the following formulas (17) to (20). These are preferred in terms of the efficiency of acid generation. Compounds represented by the following formulas (17) to (20) are more preferred.

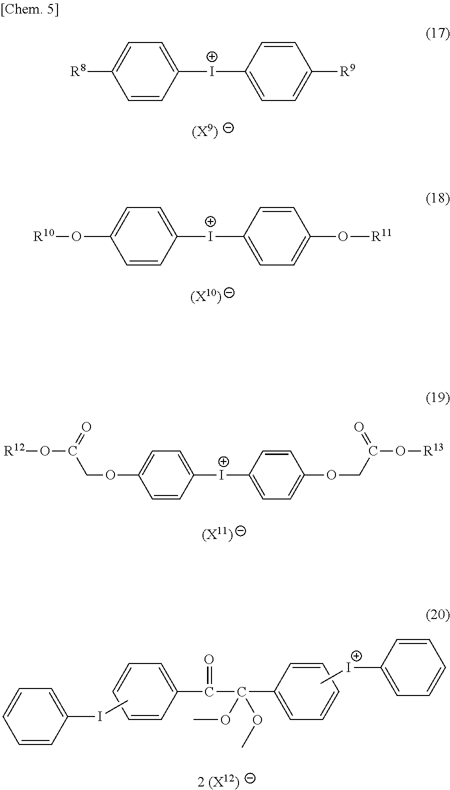

In the formulas (17) to (20), R⁸ to R¹³ are each an atom or substituent selected from the group consisting of hydrogen, halogens, and C1-C20 acyl, C1-C20 alkyl, C1-C20 alkoxy, C1-C20 alkylthio, C1-C20 alkylsilyl, nitro, carboxyl, hydroxyl, mercapto, amino, cyano, phenyl, and naphthyl groups; and (X⁹)⁻ to (X¹²)⁻ are each a negative ion.

Examples of halogens, and C1-C20 acyl, C1-C20 alkyl, C1-C20 alkoxy, C1-C20 alkylthio, and C1-C20 alkylsilyl groups include those listed above for the formulas (1) and (2).

Preferred examples of R⁸ to R¹³ include halogens, and cyano, phenyl, naphthyl, C1-C20 alkyl, C1-C20 alkoxy, and C1-C20 acyl groups. Cyano, phenyl, C1-C15 alkyl, C1-C15 alkoxy, and C1-C15 acyl groups are more preferred, and C1-C10 alkyl, C1-C10 alkoxy, and C1-C10 acyl groups are particularly preferred. The alkyl chains of these groups may be straight, branched, or cyclic.

Examples and preferred examples of (X⁹)⁻ to (X¹²)⁻ in the formulas (17) to (20) are those listed above for (X¹)⁻ and (X²)⁻ in the formulas (1) and (2).

Common photopolymerization initiators suited for curing by light of wavelengths within the visible range (360 to 830 nm; see JIS-Z 8120) themselves are colored so as to be able to absorb visible light, and the color thereof gives a bad influence on the hue of cured coatings. However, the use of a compound represented by the formula (2) or (16) eliminates such a bad influence on the hue of cured coatings.

Examples of the sulfonic acid ester derivatives (B21) include cyclohexyl methanesulfonate, isopropyl ethanesulfonate, t-butyl benzene sulfonate, cyclohexyl p-toluenesulfonate, and cyclohexyl naphthalene sulfonate.

Examples of the acetic acid ester derivatives (B22) include cyclohexyl dichloroacetate and isopropyl trichloroacetate.

Examples of the phosphonic acid esters (B23) include triphenylphosphonic acid cyclohexyl ester.

In the present invention, the base generator (C) refers to a compound that generates a base on exposure to at least one of active rays, radicals, acids, and bases, and examples thereof include known compounds such as base generators (C1) that generate a base on exposure to active rays, and base generators (C2) that generate a base on exposure to at least one species selected from the group consisting of radicals, acids, and bases.

A photosensitive composition including the base generator (C) can have high sensitivity and avoid macroscopic reaction rate distribution. This presumably enables the cured article of the present invention, which is produced by curing the photosensitive composition of the present invention, to achieve high hardness, high scratch resistance, and high transparency.

For example, oxime derivatives (C121), quaternary ammonium salt derivatives (C122), and quaternary amidine salt derivatives (C123) all generate a base on exposure to either active rays or radicals, and therefore any of these can be used as both (C1) and (C2).

Carbamate derivatives (C21) generate a base on exposure to a base, and therefore can be used as (C2).

(C) may be a single compound or may be a combination of two or more compounds.

(C121) indicates that this compound is the first example of initiators (C12) that can be used as both (C1) and (C2).

Examples of the oxime derivatives (C121) include O-acyloxime.

Examples of the carbamate derivatives (C21) include 1-Fmoc-4-piperidone and o-nitrobenzoyl carbamate.

Examples of the quaternary ammonium salt derivatives (C122) and the quaternary amidine salt derivatives (C123) include compounds represented by any one of the following formulas (21) to (23).

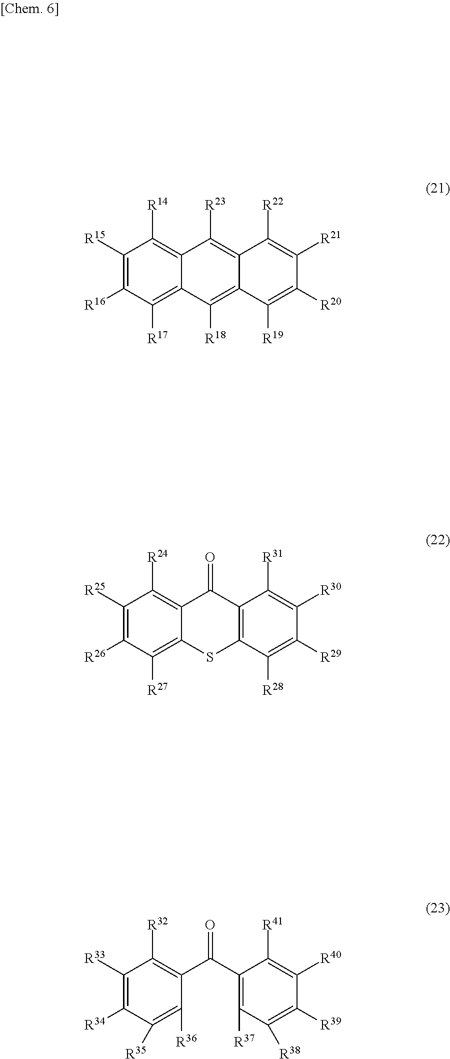

R¹⁴ to R⁴¹ in the formulas (21) to (23) are individually an atom or substituent selected from the group consisting of hydrogen, halogens, C1-C20 acyl, C1-C20 alkyl, C1-C20 alkoxy, C1-C20 alkylthio, C1-C20 alkylsilyl, nitro, carboxyl, hydroxyl, mercapto, amino, cyano, phenyl, and naphthyl groups, substituents represented by the following formula (24), and substituents represented by the following formula (25). At least one of R¹⁴ to R²³ is a substituent represented by the formula (24) or (25). At least one of R²⁴ to R³¹ is a substituent represented by the formula (24) or (25). At least one of R³² to R⁴¹ is a substituent represented by the formula (24) or (25).

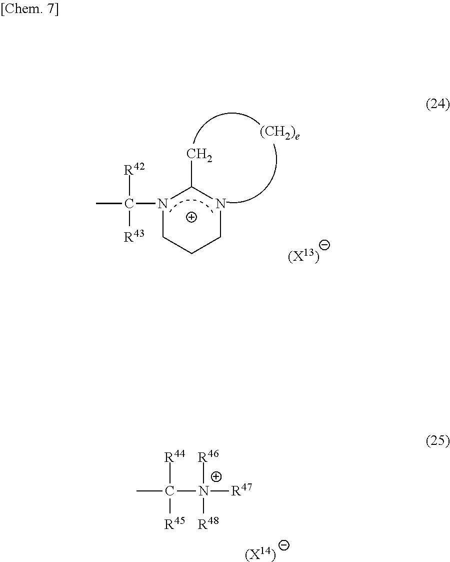

In the formulas (24) and (25), R⁴² to R⁴⁵ are each a hydrogen or C1-C20 alkyl group; R⁴⁶ to R⁴⁸ are each a C1-C20 alkyl group optionally substituted by a hydroxyl group; (X¹³)⁻ and (X¹⁴)⁻ are each a negative ion; and e is an integer of 2 to 4.

Examples of halogens, and C1-C20 acyl, C1-C20 alkyl, C1-C20 alkoxy, C1-C20 alkylthio and C1-C20 alkylsilyl groups in the formulas (21) to (23) include those listed above for the formulas (1) and (2).

Compounds represented by the formula (21), compounds represented by the formula (22), and compounds represented by the formula (23) have an anthracene structure, a thioxanthone structure, and a benzophenone structure, respectively. These compounds are examples of those having a maximum absorption wavelength of around the i-line (365 nm). R¹⁴ to R²³ are introduced for adjustment of the absorption wavelength range or sensitivity, or for modification based on a consideration of properties such as thermal stability, reactivity, and decomposability, and are each an atom or substituent selected from the group consisting of hydrogen, halogens, C1-C20 alkoxy, nitro, carboxyl, hydroxyl, mercapto, C1-C20 alkylsilyl, C1-C20 acyl, amino, cyano, C1-C20 alkyl, phenyl, and naphthyl groups, in accordance with the purpose. Here, at least one of R¹⁴ to R²³ should be a substituent represented by the formula (24) or (25).

Preferred examples of R¹⁴ to R²³ include halogens, and cyano, phenyl, naphthyl, C1-C20 alkyl, C1-C20 alkoxy, and C1-C20 acyl groups. Cyano, phenyl, C1-C15 alkyl, C1-C15 alkoxy, and C1-C15 acyl groups are more preferred, and C1-C10 alkyl, C1-C10 alkoxy, and C1-C10 acyl groups are particularly preferred. The alkyl chains of these groups may be straight, branched, or cyclic.

Specific examples of R¹⁴ to R²³ include the compounds listed for R⁸ to R¹³ in the formulas (17) to (19).

Substituents represented by the formula (24) are substituents having a cationic amidine structure, and e is an integer of 2 to 4. Preferred examples of these substituents include a substituent having the cationic form of 1,8-diazabicyclo[5.4.0]-7-undecene (e=4), and a substituent having the cationic form of 1,5-diazabicyclo[4.3.0]-5-nonene (e=2). R⁴² and R⁴³ are each a hydrogen or C1-C20 alkyl group, and preferred examples thereof include hydrogen and C1-C10 alkyl groups. Hydrogen and C1-C5 alkyl groups are more preferred.

Substituents represented by the formula (25) have a quaternary ammonium structure. R⁴⁴ and R⁴⁵ are each a hydrogen or C1-C20 alkyl group, and preferred examples thereof include hydrogen and C1-C10 alkyl groups. Hydrogen and C1-C5 alkyl groups are more preferred. R⁴⁶ to R⁴⁸ may be each a straight, branched, or cyclic C1-C20 alkyl group optionally substituted by hydroxyl group (s). Preferred examples of R⁴⁶ to R⁴⁸ include C1-C10 alkyl groups. C1-C5 alkyl groups are particularly preferred.

(X¹³)⁻ and (X¹⁴)⁻ in the formulas (24) and (25) are each a negative ion, and specific examples thereof include those listed above for (X¹)⁻ and (X²)⁻ in the formulas (1) and (2). In terms of the photodegradability, aliphatic or aromatic carboxyl ions and borate anions are preferred among the examples listed above.

In the compound represented by the formula (24), the bond between the nitrogen and the carbon to which R⁴² and R⁴³ are linked is broken by exposure to active rays, which results in formation of a basic compound having an amidine structure. In the compound represented by the formula (25), the bond between the nitrogen and the carbon to which R⁴⁴ and R⁴⁵ are linked is broken by exposure to active rays, which results in formation of a tertiary amine.

In terms of the photodegradability, compounds represented by the following formula (26) are preferred among these photobase generators (C1).

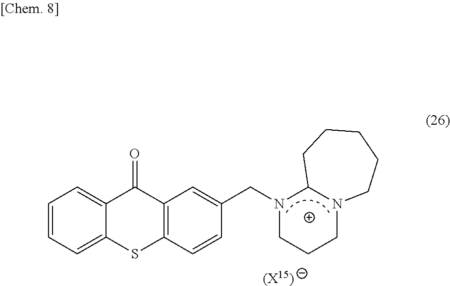

(X¹⁵)⁻ in the formula (26) is a negative ion, and specific examples thereof include those listed above for (X¹)⁻ and (X²)⁻ in the formulas (1) and (2). In terms of the photodegradability, aliphatic or aromatic carboxyl ions and borate anions are preferred among these.

Examples of the carbamate derivatives (C21) include 1-Z-4-piperidone.

Any one of the acid generator (B) and the base generator (C), when used in the photosensitive composition of the present invention, enables production of transparent cured articles having excellent adhesion to various substrates. In terms of the yellowing resistance of cured articles, preferred is the acid generator (B).

In terms of the photocurability, the amount of the acid generator (B) and/or the base generator (C) in terms of the total amount of the (B) and (C) in the photosensitive composition of the present invention is preferably 0.05 to 30% by weight, and more preferably 0.1 to 20% by weight, based on the weight of the polymerizable substance (D).

In the present invention, the following combinations (1) to (4) of (A1), (A2), (B1), (B2), (C1), and (C2) are preferred (photosensitive curable composition of a second aspect of the present invention);

(1) (A1) and at least one of (B2) and (C2);

(2) (B1), (A2), and optionally (C2);

(3) (C1), (A2), and optionally (B2); and

(4) a combination of two or more of the above (1) to (3).

In the case of the combination (1), the active species (H) that is generated on exposure to active rays is radicals, and the active species (1) is an acid and/or a base.

In the case of the combination (2), the active species (H) that is generated on exposure to active rays is an acid, and the active species (I) is radicals and optionally a base.

In the case of the combination (3), the active species (H) that is generated on exposure to active rays is a base, and the active species (I) is radicals and optionally an acid.

More preferable combinations among these are combinations including (A1) and (B2) in the combination (1); combinations including (B1) and (A2) being the compound (A12) applicable to both (A1) and (A2) in the combination (2); and combinations including (C1) and (A2) being the compound (A12) applicable to both (A1) and (A2) in the combination (3). Particularly preferable are the combinations including (A1) and (B2) and combinations including (B1) and (A12).

Examples of the polymerizable substance (D) in the present invention include known compounds such as radical polymerizable compounds (D1) and ionic polymerizable compounds (D2). (D) may be a single compound or may be a combination of two or more compounds. Preferable among these are the radical polymerizable compounds (D1) in terms of the cure rate. Optionally, polymerization inhibitor(s) such as hydroquinone and methyl ether hydroquinone may be used together.

Examples of the radical polymerizable compounds (D1) include acrylamide compounds (D11), (meth)acrylate compounds (D12), aromatic vinyl compounds (D13), vinyl ether compounds (D14), and other radical polymerizable compounds (D15).

As used herein, the term “(meth)acrylate” is used to refer to one or both “acrylate” and “methacrylate”, and the term “(meth)acryl” is used to refer to one or both “acryl” and “methacryl”.

The (meth)acrylamide compounds (D11) preferably have 3 to 35 carbon atoms, and examples thereof include (meth)acrylamide, N-methyl(meth)acrylamide, N-ethyl(meth)acrylamide, N-propyl(meth)acrylamide, N-n-butyl(meth)acrylamide, N-t-butyl(meth)acrylamide, N-butoxymethyl(meth)acrylamide, N-isopropyl(meth)acrylamide, N-methylol(meth)acrylamide, N,N-dimethyl(meth)acrylamide, N,N-diethyl(meth)acrylamide, and (meth)acryloylmorpholine.

The (meth)acrylate compounds (D12) preferably have 4 to 35 carbon atoms, and examples thereof include mono to hexafunctional (meth)acrylates.

Here, “mono to hexafunctional (meth)acrylates” means (meth)acrylates having 1 to 6 (meth)acryloyl group(s), and similar expressions will be construed in the same way hereinafter.

Examples of monofunctional (meth)acrylates include ethyl (meth)acrylate, hexyl(meth)acrylate, 2-ethylhexyl(meth)acrylate, tert-octyl(meth)acrylate, isoamyl(meth)acrylate, decyl(meth)acrylate, isodecyl(meth)acrylate, stearyl(meth)acrylate, isostearyl(meth)acrylate, cyclohexyl(meth)acrylate, 4-n-butylcyclohexyl(meth)acrylate, bornyl(meth)acrylate, isobornyl(meth)acrylate, benzyl (meth)acrylate, 2-ethylhexyl diglycol(meth)acrylate, butoxyethyl(meth)acrylate, 2-chloroethyl(meth)acrylate, 4-bromobutyl(meth)acrylate, cyanoethyl(meth)acrylate, butoxymethyl(meth)acrylate, methoxypropylene mono(meth)acrylate, 3-methoxybutyl(meth)acrylate, alkoxymethyl(meth)acrylates, 2-ethylhexyl calbitor(meth)acrylate, alkoxyethyl(meth)acrylates, 2-(2-methoxyethoxy)ethyl (meth)acrylate, 2-(2-butoxyethoxy)ethyl (meth)acrylate, 2,2,2-tetrafluoroethyl(meth)acrylate, 1H,1H,2H,2H-perfluorodecyl(meth)acrylate, 4-butylphenyl(meth)acrylate, phenyl(meth)acrylate, 2,4,5-tetramethylphenyl(meth)acrylate, 4-chlorophenyl(meth)acrylate, phenoxymethyl(meth)acrylate, phenoxyethyl(meth)acrylate, glycidyl(meth)acrylate, glycidyloxybutyl(meth)acrylate, glycidyloxyethyl(meth)acrylate, glycidyloxypropyl(meth)acrylate, diethyleneglycol monovinyl ether mono(meth)acrylate, tetrahydrofurfuryl(meth)acrylate, hydroxyalkyl(meth)acrylates, 2-hydroxyethyl(meth)acrylate, 3-hydroxypropyl(meth)acrylate, 2-hydroxypropyl(meth)acrylate, 2-hydroxybutyl(meth)acrylate, 4-hydroxybutyl(meth)acrylate, dimethylaminoethyl(meth)acrylate, diethylaminoethyl(meth)acrylate, dimethylaminopropyl(meth)acrylate, diethylaminopropyl(meth)acrylate, trimethoxysilylpropyl(meth)acrylate, trimethoxysilylpropyl(meth)acrylate, trimethylsilypropyl(meth)acrylate, polyethylene oxide monomethyl ether(meth)acrylate, oligoethylene oxide monomethyl ether(meth)acrylate, polyethylene oxide(meth)acrylate, oligoethylene oxide(meth)acrylate, oligoethylene oxide monoalkyl ether(meth)acrylates, polyethylene oxide monoalkyl ether(meth)acrylates, dipropylene glycol(meth)acrylate, polypropylene oxide monoalkyl ether(meth)acrylates, oligopropylene oxide monoalkyl ether(meth)acrylates, 2-methacryloyloxyethylsuccinic acid, 2-methacryloyloxyhexahydrophthalic acid, 2-methacryloyloxyethyl-2-hydroxypropyl phthalate, butoxydiethylene glycol(meth)acrylate, trifluoroethyl(meth)acrylate, perfluorooctylethyl(meth)acrylate, 2-hydroxy-3-phenoxypropyl(meth)acrylate, ethylene oxide (referred to as EO hereinafter)-modified phenol(meth)acrylate, EO-modified cresol(meth)acrylate, EO-modified nonylphenol(meth)acrylate, propylene oxide (referred to as PO hereinafter)-modified nonylphenol(meth)acrylate, and EO-modified 2-ethylhexyl(meth)acrylate.

Examples of bifunctional (meth)acrylates include 1,4-butane di(meth)acrylate, 1,6-hexane di(meth)acrylate, polypropylene di(meth)acrylate, 1,6-hexanediol di(meth)acrylate, 1,10-decanediol di(meth)acrylate, neopentyl di(meth)acrylate, neopentyl glycol di(meth)acrylate, 2,4-dimethyl-1,5-pentanediol di(meth)acrylate, butylethylpropanediol di(meth)acrylate, ethoxylated cyclohexane methanol di(meth)acrylate, polyethylene glycol di(meth)acrylate, oligoethylene glycol di(meth)acrylate, ethylene glycol di(meth)acrylate, 2-ethyl-2-butyl-butanediol di(meth)acrylate, neopentyl glycol hydroxypivalate di(meth)acrylate, EO-modified bisphenol A di(meth)acrylate, bisphenol F polyethoxy di(meth)acrylate, polypropylene glycol di(meth)acrylate, oligopropylene glycol di(meth)acrylate, 1,4-butanediol di(meth)acrylate, 2-ethyl-2-butyl-propanediol di(meth)acrylate, 1,9-nonane di(meth)acrylate, propoxylated ethoxylated bisphenol A di(meth)acrylate, and tricyclodecane di(meth)acrylate.

Examples of trifunctional (meth)acrylates include trimethylolpropane tri(meth)acrylate, trimethylolethane tri(meth)acrylate, alkyleneoxide-modified trimethylolpropane tri(meth)acrylates, pentaerythritol tri(meth)acrylate, dipentaerythritol tri(meth)acrylate, trimethylolpropane tri((meth)acryloyloxypropyl)ether, isocyanuric acid alkylene oxide-modified tri(meth)acrylates, dipentaerythritol propionate tri(meth)acrylate, tri((meth)acryloyloxyethyl)isocyanurate, hydroxypivalaldehyde-modified dimethylolpropane tri(meth)acrylate, sorbitol tri(meth)acrylate, a tri(meth)acrylate of a pentaerythritol C2-C4 alkylene oxide (1 to 30 mol) adduct, and ethoxylated glycerin tri(meth)acrylate.

Examples of tetrafunctional (meth)acrylates include pentaerythritol tetra(meth)acrylate, sorbitol tetra(meth)acrylate, ditrimethylolpropane tetra(meth)acrylate, dipentaerythritol tetra(meth)acrylate, dipentaerythritol propionate tetra(meth)acrylate, and a tetra(meth)acrylate of a pentaerythritol C2-C4 alkylene oxide (1 to 30 mol) adduct.

Examples of pentafunctional (meth)acrylates include sorbitol penta(meth)acrylate and dipentaerythritol penta(meth)acrylate.

Examples of hexafunctional (meth)acrylates include dipentaerythritol hexa(meth)acrylate, sorbitol hexa(meth)acrylate, alkylene oxide-modified phosphazene hexa(meth)acrylates, and caprolactone-modified dipentaerythritol hexa(meth)acrylate.

Examples of C6-C35 aromatic vinyl compounds (D13) include vinyl thiophene, vinyl furan, vinyl pyridine, styrene, methyl styrene, trimethylstyrene, ethylstyrene, isopropylstyrene, chloromethylstyrene, methoxystyrene, acetoxystyrene, chlorostyrene, dichlorostyrene, bromostyrene, methyl vinyl benzoate, 3-methylstyrene, 4-methylstyrene, 3-ethylstyrene, 4-ethylstyrene, 3-propylstyrene, 4-propylstyrene, 3-butylstyrene, 4-butylstyrene, 3-hexylstyrene, 4-hexylstyrene, 3-octylstyrene, 4-octylstyrene, 3-(2-ethylhexyl)styrene, 4-(2-ethylhexyl)styrene, allylstyrene, isopropenylstyrene, butenylstyrene, octenylstyrene, 4-t-butoxycarbonylstyrene, 4-methoxystyrene, and 4-t-butoxystyrene.

The vinyl ether compounds (D14) preferably contain 3 to 35 carbon atoms, and examples thereof include following monofunctional or multifunctional vinyl ethers.

Here, the “monofunctional vinyl ethers” means vinyl ether compounds having one vinyl group, and the “multifunctional vinyl ethers” means vinyl ether compounds having two or more vinyl groups.

Examples of the monofunctional vinyl ethers include methyl vinyl ether, ethyl vinyl ether, propyl vinyl ether, n-butyl vinyl ether, t-butyl vinyl ether, 2-ethyl hexyl vinyl ether, n-nonyl vinyl ether, lauryl vinyl ether, cyclohexyl vinyl ether, cyclohexylmethyl vinyl ether, 4-methylcyclohexylmethyl vinyl ether, benzyl vinyl ether, dicyclopentenyl vinyl ether, 2-dicyclopentenoxyethyl vinyl ether, methoxyethyl vinyl ether, ethoxyethyl vinyl ether, butoxyethyl vinyl ether, methoxyethoxy ethyl vinyl ether, ethoxyethoxy ethyl vinyl ether, methoxy polyethylene glycol vinyl ether, tetrahydrofurfuryl vinyl ether, 2-hydroxyethyl vinyl ether, 2-hydroxypropyl vinyl ether, 4-hydroxybutyl vinyl ether, 4-hydroxymethylcyclohexylmethyl vinyl ether, diethylene glycol monovinyl ether, polyethylene glycol vinyl ether, chloroethyl vinyl ether, chlorobutyl vinyl ether, chloroethoxyethyl vinyl ether, phenylethyl vinyl ether, and phenoxypolyethylene glycol vinyl ether.

Examples of the multifunctional vinyl ethers include divinyl ethers such as ethylene glycol divinyl ether, diethylene glycol divinyl ether, polyethylene glycol divinyl ether, propylene glycol divinyl ether, butylene glycol divinyl ether, hexanediol divinyl ether, bisphenol A alkylene oxide divinyl ethers, and bisphenol F alkylene oxide divinyl ethers; and trimethylolethane trivinyl ether, trimethylolpropane trivinyl ether, ditrimethylolpropane tetravinyl ether, glycerin trivinyl ether, pentaerythritol tetravinyl ether, dipentaerythritol pentavinyl ether, dipentaerythritol hexavinyl ether, an EO adduct of trimethylolpropane trivinyl ether, a PO adduct of trimethylolpropane trivinyl ether, an EO adduct of ditrimethylolpropane tetravinyl ether, a PO adduct of ditrimethylolpropane tetravinyl ether, an EO adduct of pentaerythritol tetravinyl ether, a PO adduct of pentaerythritol tetravinyl ether, an EO adduct of dipentaerythritol hexavinyl ether, and a PO adduct of dipenta erythritol hexavinyl ether.

Examples of the other radical polymerizable compounds (D15) include acrylonitrile, vinyl ester compounds (e.g. vinyl acetate, vinyl propionate, vinyl versatate), allyl ester compounds (e.g. allyl acetate), halogen-containing monomers (e.g. vinylidene chloride, vinyl chloride), and olefin compounds (e.g. ethylene, propylene).

In terms of the cure rate, the C3-C35 acryl amide compounds, the C4-C35 (meth)acrylate compounds, the C6-C35 aromatic vinyl compounds, and the C3-C35 vinyl ether compounds are preferred among these. The C3-C35 acryl amide compounds and the C4-C35 (meth)acrylate compounds are more preferred.

Examples of the ionic polymerizable compounds (D2) include C3-C20 epoxy compounds (D21) and C4-C20 oxetane compounds (D22).

Examples of the C3-C20 epoxy compounds (D21) include the following monofunctional or multifunctional epoxy compounds.

Here, the “monofunctional epoxy compounds” means epoxy compounds having one epoxy group, and the “multifunctional epoxy compounds” means epoxy compounds having two or more epoxy groups.

Examples of the monofunctional epoxy compounds include phenyl glycidyl ether, p-tert-butylphenyl glycidyl ether, butyl glycidyl ether, 2-ethylhexyl glycidyl ether, allyl glycidyl ether, 1,2-butylene oxide, 1,3-butadiene monooxide, 1,2-epoxydodecane, epichlorohydrin, 1,2-epoxydecane, styrene oxide, cyclohexene oxide, 3-methacryloyloxymethylcyclohexene oxide, 3-acryloyloxymethylcyclohexene oxide, and 3-vinyl cyclohexene oxide.

Examples of the multifunctional epoxy compounds include bisphenol A diglycidyl ether, bisphenol F diglycidyl ether, bisphenol S diglycidyl ether, brominated bisphenol A diglycidyl ether, brominated bisphenol F diglycidyl ether, brominated bisphenol S diglycidyl ether, epoxy novolac resin, hydrogenated bisphenol A diglycidyl ether, hydrogenated bisphenol F diglycidyl ether, hydrogenated bisphenol S diglycidyl ether, 3,4-epoxycyclohexylmethyl-3′,4′-epoxycyclohexane carboxylate, 2-(3,4-epoxycyclohexyl-5,5-spiro-3,4-epoxy)cyclohexane-meta-dioxane, bis(3,4-epoxycyclohexylmethyl)adipate, vinyl cyclohexene oxide, 4-vinyl epoxycyclohexane, bis(3,4-epoxy-6-methylcyclohexylmethyl)adipate, 3,4-epoxy-6-methylcyclohexyl-3′,4′-epoxy-6′-methylcyclohexane carboxylate, methylene bis(3,4-epoxycyclohexane), dicyclopentadiene diepoxide, ethylene glycol di(3,4-epoxycyclohexylmethyl)ether, ethylene bis(3,4-epoxycyclohexane carboxylate), dioctyl epoxyhexahydrophthalate, di-2-ethylhexyl epoxyhexahydrophthalate, 1,4-butanediol diglycidyl ether, 1,6-hexanediol diglycidyl ether, glycerin triglycidyl ether, trimethylolpropane triglycidyl ether, polyethylene glycol diglycidyl ether, polypropylene glycol diglycidyl ethers, 1,1,3-tetradecadiene dioxide, limonene dioxide, 1,2,7,8-diepoxyoctane, and 1,2,5,6-diepoxy cyclooctane.

In terms of the cure rate, aromatic or alicyclic epoxides are preferred among these epoxide compounds. Particularly preferred are alicyclic epoxides.

Examples of the C4-C20 oxetane compounds (D22) include compounds containing one to six oxetane rings.

Examples of compounds containing one oxetane ring include 3-ethyl-3-hydroxymethyloxetane, 3-(meth)allyloxymethyl-3-ethyloxetane, (3-ethyl-3-oxetanylmethoxy)methylbenzene, 4-fluoro-[1-(3-ethyl-3-oxetanylmethoxy)methyl]benzene, 4-methoxy-[1-(3-ethyl-3-oxetanylmethoxy)methyl]benzene, [1-(3-ethyl-3-oxetanylmethoxy)ethyl]phenyl ether, isobutoxymethyl(3-ethyl-3-oxetanylmethyl)ether, isobornyloxyethyl(3-ethyl-3-oxetanylmethyl)ether, isobornyl(3-ethyl-3-oxetanylmethyl)ether, 2-ethylhexyl(3-ethyl-3-oxetanylmethyl)ether, ethyldiethylene glycol(3-ethyl-3-oxetanylmethyl)ether, dicyclopentadiene(3-ethyl-3-oxetanylmethyl)ether, dicyclopentenyloxyethyl(3-ethyl-3-oxetanylmethyl)ether, dicyclopentenyl(3-ethyl-3-oxetanylmethyl)ether, tetrahydrofurfuryl(3-ethyl-3-oxetanylmethyl)ether, tetrabromophenyl(3-ethyl-3-oxetanylmethyl)ether, 2-tetrabromophenoxyethyl(3-ethyl-3-oxetanylmethyl)ether, tribromophenyl(3-ethyl-3-oxetanylmethyl)ether, 2-tribromophenoxyethyl(3-ethyl-3-oxetanylmethyl)ether, 2-hydroxyethyl(3-ethyl-3-oxetanylmethyl)ether, 2-hydroxypropyl(3-ethyl-3-oxetanylmethyl)ether, butoxyethyl(3-ethyl-3-oxetanylmethyl)ether, pentachlorophenyl(3-ethyl-3-oxetanylmethyl)ether, pentabromophenyl(3-ethyl-3-oxetanylmethyl)ether, and bornyl(3-ethyl-3-oxetanylmethyl)ether.

Examples of compounds containing two to six oxetane rings include 3,7-bis(3-oxetanyl)-5-oxa-nonan, 3,3′-(1,3-(2-methylenyl)propanediyl bis(oxymethylene))bis-(3-ethyloxetane), 1,4-bis[(3-ethyl-3-oxetanylmethoxy)methyl]benzene, 1,2-bis[(3-ethyl-3-oxetanylmethoxy)methyl]ethane, 1,3-bis[(3-ethyl-3-oxetanylmethoxy)methyl]propane, ethylene glycol bis(3-ethyl-3-oxetanylmethyl)ether, dicyclopentenyl bis(3-ethyl-3-oxetanylmethyl)ether, triethylene glycol bis(3-ethyl-3-oxetanylmethyl)ether, tetraethylene glycol bis(3-ethyl-3-oxetanylmethyl)ether, tricyclodecanediyl dimethylene(3-ethyl-3-oxetanylmethyl)ether, trimethylolpropane tris(3-ethyl-3-oxetanylmethyl)ether, 1,4-bis(3-ethyl-3-oxetanylmethoxy)butane, 1,6-bis(3-ethyl-3-oxetanylmethoxy)hexane, pentaerythritol tris(3-ethyl-3-oxetanylmethyl)ether, pentaerythritol tetrakis(3-ethyl-3-oxetanylmethyl)ether, polyethylene glycol bis(3-ethyl-3-oxetanylmethyl)ether, dipentaerythritol hexakis(3-ethyl-3-oxetanylmethyl)ether, dipentaerythritol pentakis(3-ethyl-3-oxetanylmethyl)ether, dipentaerythritol tetrakis(3-ethyl-3-oxetanylmethyl)ether, caprolactone-modified dipentaerythritol hexakis(3-ethyl-3-oxetanylmethyl)ether, caprolactone-modified dipentaerythritol pentakis (3-ethyl-3-oxetanylmethyl)ether, ditrimethylolpropane tetrakis(3-ethyl-3-oxetanylmethyl)ether, EO-modified bisphenol A bis(3-ethyl-3-oxetanylmethyl)ether, PO-modified bisphenol A bis(3-ethyl-3-oxetanylmethyl)ether, EO-modified hydrogenated bisphenol A bis(3-ethyl-3-oxetanylmethyl)ether, PO-modified hydrogenated bisphenol A bis(3-ethyl-3-oxetanylmethyl)ether, and EO-modified bisphenol F (3-ethyl-3-oxetanylmethyl)ether.

In terms of the cure rate, compounds containing one or two oxetane rings are preferred among these.

The polymerizable substance (D) is more preferably one of the following combinations [1] to [4] of the radical polymerizable compounds (D1) according to its application and purpose:

[1] a combination of a compound that contains a monofunctional (meth)acrylate (Da) containing one or more hydroxyl groups, a monofunctional (meth)acrylate (Db) containing a vinyl ether group and/or allyl ether group and not containing hydroxyl groups, and a (meth)acrylate (Dc) with three or more functional groups, containing one or more hydroxyl groups;

[2] a compound that contains a (meth)acrylate (Dc) with three or more functional groups, containing one or more hydroxyl groups; and 4-(meth)acryloylmorpholine (Dd)

[3] a compound that contains at least one ester compound (De) selected from the group consisting of phthalic acid esters that contain an ethylenically unsaturated bond-containing group, trimellitic acid esters, and pyromellitic acid esters; and optionally a urethane and/or urea group-containing (meth)acrylate (Df); and

[4] a compound that contains a (meth)acrylate (Dg) having a cyclic ether skeleton; and a C1-C24 alkyl group-containing alkyl(meth)acrylate (Dh), provided that the photosensitive composition contains a (meth)acryl resin (E) which is a copolymer of at least two kinds of radical polymerizable monomers.

The combinations [1] and [2] of the radical polymerizable compounds (D1) are suitable for a photosensitive composition for hard coating, which provides a cured film with excellent surface protection function with high hardness as well as high adhesion and high transparency.

The combination [3] of the radical polymerizable compounds (D1) is suitable for a photosensitive composition for hard coating, which provides a cured film with excellent surface protection function with especially high hardness as well as high adhesion and high transparency; and a photosensitive composition for resist excellent in developing property.

The combination [4] of the radical polymerizable compounds (D1) is suitable for a photosensitive composition for adhesive agent, which provides a cured film with high heat resistance as well as high transparency and, especially, high adhesion.

The combination [1] of the radical polymerizable compounds (D1) includes a monofunctional (meth)acrylate (Da) containing one or more hydroxyl groups; a monofunctional (meth)acrylate (Db) containing a vinyl ether group and/or allyl ether group and not containing hydroxyl groups; and a (meth)acrylate (Dc) with three or more functional groups, containing one or more hydroxyl groups.

Examples of the monofunctional (meth)acrylate (Da) containing one or more hydroxyl groups include mono(meth)acrylates of a C2-C80 aliphatic or alicyclic polyhydric alcohol, and appropriate ones among the listed mono(meth)acrylates in the (meth)acrylate compound (D12). The C2-C80 aliphatic or alicyclic polyhydric alcohol may have —O— or —COO— in the molecular chain.

Specific examples of (Da) include 2-hydroxyethyl(meth)acrylate, 2-hydroxypropyl(meth)acrylate, 2-hydroxybutyl(meth)acrylate, 4-hydroxybutyl(meth)acrylate, pentaerythritol mono(meth)acrylate, dipentaerythritol mono(meth)acrylate, 3-hydroxy-1-adamanthyl(meth)acrylate, 1,4-cyclohexanedimethanol mono(meth)acrylate, glycerol mono(meth)acrylate, and (meth)acrylates represented by anyone of the formulas (27) to (31). Any of these (Da)s may be used alone, or two or more of these may be used in combination.

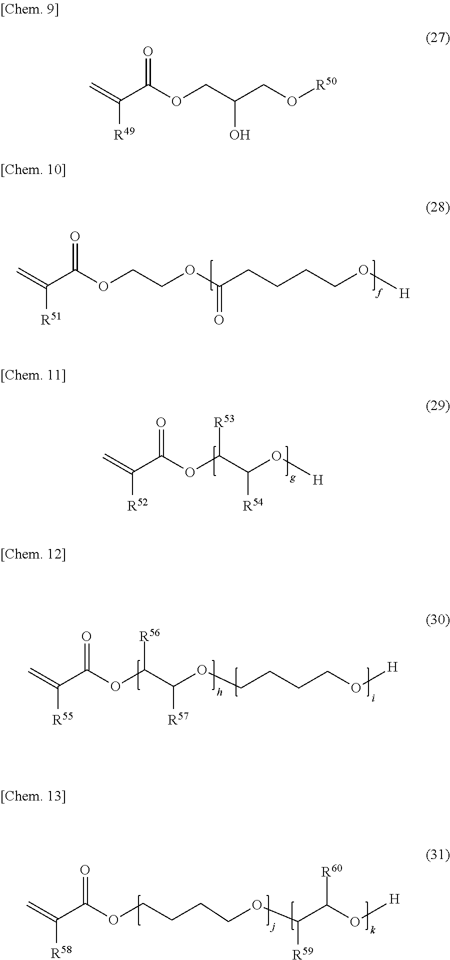

In the formulas, R⁴⁹ and R⁵¹ to R⁶⁰ each independently represent a hydrogen atom or a methyl group. When multiple R⁵³s, R⁵⁴s, R⁵⁶s, R⁵⁷s, R⁵⁹s, or R⁶⁰s are present, the R⁵³s, R⁵⁴s, R⁵⁶s, R⁵⁷s, R⁵⁹s, and R⁶⁰s are each independently the same as or different from one another. R⁵⁰ represents a C1-C18 monovalent aliphatic hydrocarbon group, f represents an integer of 1 to 5, g represents an integer of 2 to 10, and h, i, j, and k each independently represent an integer of 0 to 10. The pairs h and i, and j and k each do not simultaneously represent 0.

In terms of the surface hardness and adhesion, preferable among these are hydroxy alkyl(meth)acrylates containing a C2-C4 hydroxy alkyl group, and more preferably 2-hydroxyethyl(meth)acrylate and 4-hydroxybutyl(meth)acrylate.

In selecting the combination [1] of the radical polymerizable compounds (D1), the amount of monofunctional (meth)acrylate (Da) containing one or more hydroxyl groups in the photosensitive composition of the present invention is preferably 1 to 80% by weight, and more preferably 3 to 40% by weight, based on the weight of the photosensitive composition in terms of the surface hardness and adhesion.

In the combination [1] of the radical polymerizable compounds (D1), examples of the monofunctional (meth)acrylate (Db) containing a vinyl ether group and/or allyl ether group and not containing hydroxyl groups include at least one (meth)acrylate selected from the group consisting of (meth)acrylates containing a vinyl ether group or allyl ether group represented by the formula (32), and (meth)acrylates of a C2-C8 aliphatic or alicyclic diol vinyl ether.

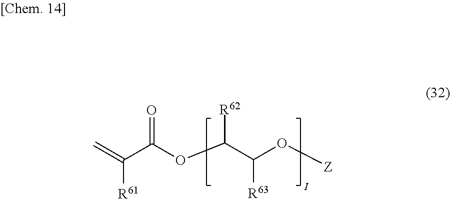

In the formula, Z represents a vinyl or allyl group, R⁶¹, R⁶², and R⁶³ each independently represent a hydrogen atom or a methyl group. When multiple R⁶²s or R⁶³s are present, the R⁶²s and R⁶³s may be each independently the same as or different from each other. The symbol l represents an integer of 1 to 10.

Examples of the C2-C8 aliphatic or alicyclic diol include ethylene glycol, 1,2-propylene glycol, 1,3-butanediol, 1,4-butanediol, 1,6-hexanediol, 3-methyl pentanediol, diethylene glycol, neopentyl glycol, 1,4-cyclohexanediol, and 1,4-bis(hydroxymethyl)cyclohexane.

Specific examples of (Db) include 2-(2-vinyloxy ethoxy)ethyl (meth)acrylate, 2-(2-allyloxy ethoxy)ethyl (meth)acrylate, 1,4-cyclohexanediol vinyl ether(meth)acrylate, and ethylene glycol vinyl ether(meth)acrylate. Any of these (Db)s may be used alone, or two or more of these may be used in combination.

In terms of the surface hardness and adhesion, preferable among these are (meth)acrylates containing a vinyl ether or allyl ether group represented by the formula (32), more preferably 2-vinyloxy ethoxy alkyl(meth)acrylate [containing a C2-C4 alkyl group], and particularly preferably 2-(2-vinyloxy ethoxy)ethyl (meth)acrylate.

In selecting the combination [1] of the radical polymerizable compounds (D1), the amount of the monofunctional (meth)acrylate (Db) containing a vinyl ether and/or allyl ether group and not containing hydroxyl groups in the photosensitive composition of the present invention is preferably 1 to 80% by weight, and more preferably 3 to 40% by weight, based on the weight of the photosensitive composition in terms of the surface hardness and adhesion.

In the combination [1] of the radical polymerizable compounds (D1), examples of the (meth)acrylate (Dc) with three or more functional groups (preferably three to six functional groups), containing one or more hydroxyl groups include appropriate ones among the listed tri- to hexafunctional (meth)acrylates included in the (meth)acrylate compound (D12), for example, at least one (meth)acrylate selected from the group consisting of poly(meth)acrylates of a C5-C12 tetravalent or more aliphatic or alicyclic polyhydric alcohol, and poly(meth)acrylates of the polyhydric alcohol C2-C4 alkyleneoxide (1 to 30 mol) adduct. Any of these (Dc)s may be used alone, or two or more of these may be used in combination.

In terms of the surface hardness and adhesion, preferable examples of the (Dc) include pentaerythritol tri(meth)acrylate, dipentaerythritol tri(meth)acrylate, dipentaerythritol tetra(meth)acrylate, dipentaerythritol penta(meth)acrylate, sorbitol tri(meth)acrylate, sorbitol tetra(meth)acrylate, sorbitol penta(meth)acrylate and tri(meth)acrylates of a pentaerythritol C2-C4 alkylene oxide (1 to 10 mol) adduct, and more preferably pentaerythritol tri(meth)acrylate.

In selecting the combination [1] of the radical polymerizable compounds (D1), the amount of the (meth)acrylate (Dc) with three or more functional groups, containing one or more hydroxyl groups in the photosensitive composition of the present invention is preferably 1 to 90% by weight, more preferably 5 to 80% by weight, based on the weight of the photosensitive composition in terms of the surface hardness and adhesion.

The combination [2] of the radical polymerizable compounds (D1) include a (meth)acrylate (Dc) with three or more functional groups, containing one or more hydroxyl groups, and 4-(meth)acryloyl morpholine (Dd).

Specific examples and preferred examples of the (meth)acrylate (Dc) with three or more functional groups, containing one or more hydroxyl groups include those listed for the combination [1].

In selecting the combination [2] of the radical polymerizable compounds (D1), the amount of the (meth)acrylate (Dc) with three or more functional groups, containing one or more hydroxyl groups in the photosensitive composition of the present invention is preferably 1 to 90% by weight, more preferably 3 to 85% by weight, and particularly preferably 5 to 80% by weight, based on the weight of the photosensitive composition in terms of the surface hardness and adhesion.

In the combination [2] of the radical polymerizable compounds (D1), use of 4-(meth)acryloyl morpholine (Dd) improves the adhesion of the resulting cured article.

In selecting the combination [2] of the radical polymerizable compounds (D1), the amount of the 4-(meth)acryloyl morpholine (Dd) in the photosensitive composition of the present invention is preferably 1 to 80% by weight, and more preferably 3 to 60% by weight, based on the weight of the photosensitive composition in terms of the surface hardness and adhesion.

The combination [3] of the radical polymerizable compounds (D1) contains at least one ester compound (De) selected from the group consisting of phthalic acid esters that contain an ethylenically unsaturated bond-containing group, trimellitic acid esters, and pyromellitic acid esters; and optionally a urethane and/or urea group-containing (meth)acrylate (Df).

The ester compound (De) is produced, for example, by reacting a compound that contains an ethylenically unsaturated bond-containing group (x) and a hydroxyl group with at least one acid selected from the group consisting of phthalic acids (including isophthalic acid and terephthalic acid), trimellitic acid, and pyromellitic acid.

In terms of the curability, preferable examples of the ethylenically unsaturated bond-containing group (x) of the ester compound (De) include (meth)acryloyl, vinyl, 1-propenyl, and allyl groups, and more preferably allyl groups.

If the ester compound (De) has a plurality of the (x), those (x)s may be the same as or different from one another.

Preferable examples of the ester compound (De) include compounds represented by the formulas (33) to (35). Any of these (De)s may be used alone, or two or more of these may be used in combination.

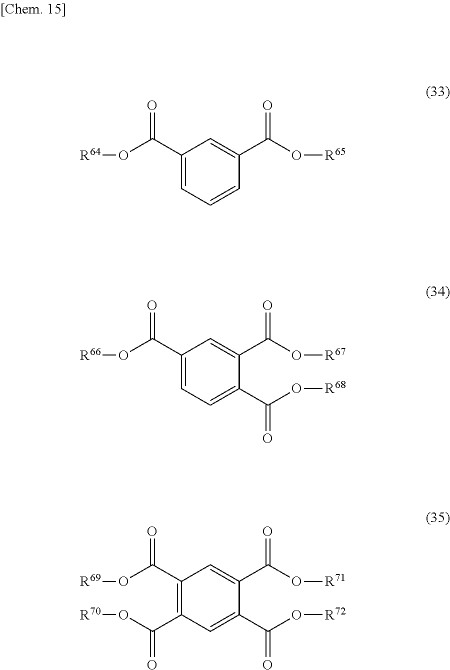

In the formulas (33) to (35), R⁶⁴ to R⁷² each independently represent a monovalent substitute represented by any one of the formulas (36) to (40).

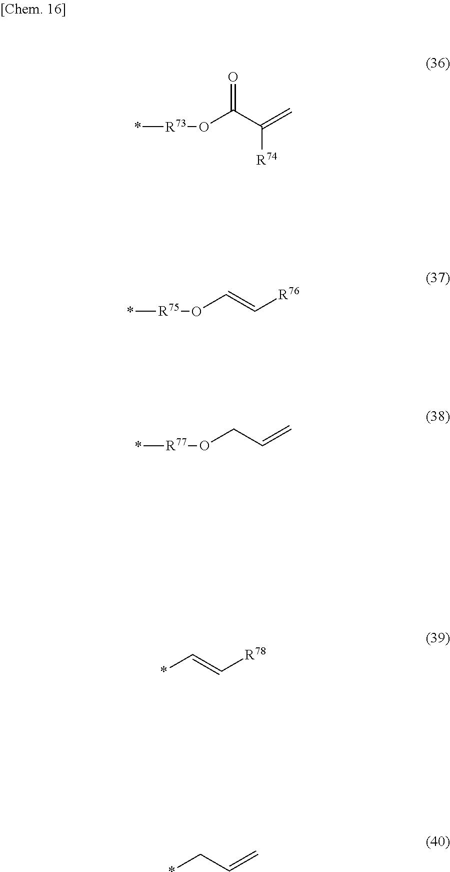

In the formulas (36) to (40), R⁷³, R⁷⁵, and R⁷⁷ each independently represent a C2-C12 divalent aliphatic hydrocarbon group, R⁷⁴, R⁷⁶, and R⁷⁸ each independently represent a hydrogen atom or a methyl group, and these substitutes are each linked to the oxygen atom of an oxycarbonyl group of the compounds represented by the formulas (33) to (35) through the position marked by *.

Among the compounds represented by the formulas (33) to (35), preferable are the compounds represented by the formula (33) or (34), and more preferably the compounds represented by the formula (34), in terms of the surface hardness and adhesion. Among the substitutes represented by the formulas (36) to (40), preferable are the substitutes represented by the formula (36), (39), or (40), and more preferably the substitutes represented by the formula (40), in terms of the surface hardness and adhesion.

Particularly preferable among these in terms of the surface hardness and adhesion are compounds represented by the formula (34) in which R⁶⁶ to R⁶⁸ are the substitutes represented by the formula (36) in which R⁷³ represents an ethylene group and R⁷⁴ represents a hydrogen atom; compounds represented by the formula (34) in which R⁶⁶ to R⁶⁸ are the substitutes represented by the formula (39) in which R⁷⁸ represents a hydrogen atom; compounds represented by the formula (34) in which R⁶⁶ to R⁶⁸ are the substitutes represented by the formula (40); compounds represented by the formula (35) in which R⁶⁹ to R⁷² are the substitutes represented by the formula (36) in which R⁷³ represents an ethylene group and R⁷⁴ represents a hydrogen atom; and compounds represented by the formula (35) in which R⁶⁹ to R⁷² are the substitutes represented by the formula (39) in which R⁷⁸ represents a hydrogen atom. Most preferable among these are the compounds represented by the formula (34) in which R⁶⁶ to R⁶⁸ are substitutes represented by the formula (40).

The ester compound (De) is produced by, for example, reacting an acid such as trimellitic acid with a compound that contains an ethylenically unsaturated bond-containing group (x) and a hydroxyl group in an organic solvent, optionally in the presence of an acid catalyst (e.g. paratoluene sulfonic acid), and then evaporating the organic solvent under reduced pressure.

In the combination [3] of the radical polymerizable compounds (D1), the amount of the ester compound (De) in the photosensitive composition of the present invention is preferably 1 to 80% by weight, and more preferably 5 to 40% by weight, based on the weight of the photosensitive composition, in terms of the surface hardness and adhesion.

The combination [3] of the radical polymerizable compounds (D1) may optionally contain a urethane and/or urea group-containing (meth)acrylate (Df). Use of the (Df) further improves the adhesion.

Examples of the urethane and/or urea group-containing (meth)acrylate (Df) include a (meth)acrylate obtainable by reacting an active hydrogen component (m) that contains a hydroxyl group-containing (meth)acrylate with an organic polyisocyanate component (n). Any of these (Df)s may be used alone, or two or more of these may be used in combination.

Examples of the hydroxyl group-containing (meth)acrylate of the active hydrogen component (m) include appropriate ones among the listed (meth)acrylate compounds (D12), for example, C5-C8 hydroxy alkyl(meth)acrylates [e.g. hydroxyethyl(meth)acrylate, hydroxypropyl(meth)acrylate], pentaerythritol di(meth)acrylate, pentaerythritol tri(meth)acrylate, and dipentaerythritol penta(meth)acrylate.

Preferable among these are hydroxyethyl(meth)acrylate, pentaerythritol di(meth)acrylate, pentaerythritol tri(meth)acrylate, and dipentaerythritol penta(meth)acrylate in terms of the curability.

The active hydrogen component (m) contains polyols, chain extenders, and the like in addition to the hydroxyl group-containing (meth)acrylate.

Examples of the polyol include polymeric polyols having a hydroxyl equivalent weight (average molecular weight per hydroxyl group, calculated from hydroxyl value) of 150 or more, and low-molecular-weight polyols having a hydroxyl equivalent weight of less than 150.

Examples of the polymeric polyols having a hydroxyl equivalent weight of 150 or more include polyether polyols and polyester polyols.

Examples of the polyether polyol include aliphatic polyether polyols and aromatic ring-containing polyether polyols.

Examples of the aliphatic polyether polyol include polyoxyethylene polyols (e.g. polyethylene glycol), polyoxypropylene polyols (e.g. polypropylene glycol), polyoxyethylene/propylene polyols and polytetramethylene ether glycol.

Examples of the aromatic polyether polyol include polyols with a bisphenol skeleton, for example, EO adducts of bisphenol A [e.g. 2 mol adduct, 4 mol adduct, 6 mol adduct, 8 mol adduct, 10 mol adduct, and 20 mol adduct], PO adduct of bisphenol A [e.g. 2 mol adduct, 3 mol adduct, and 5 mol adduct], and EO or PO adducts of resorcin.

The polyether polyol is obtainable by ring-opening addition reaction of EO or PO to an aliphatic or aromatic low-molecular-weight compound containing an active hydrogen atom in the presence of an adduct catalyst (known catalyst such as alkali metal hydroxide and Lewis acid).

The number average molecular weight (hereinafter, abbreviated as Mn) of the polyether polyol is normally 300 or more, preferably 300 to 10,000, and more preferably 300 to 6,000.

The number average molecular weight of the polyol in the present invention is measured by gel permeation chromatography (GPC) using tetrahydrofuran as a solvent and polyethylene glycol as standard. However, the Mns of the low-molecular-weight polyols are calculated from their chemical formulas.

Examples of the polyester polyol include condensation-type polyesters, polylactone polyols, polycarbonate polyols, and castor oil-based polyols.

The condensation-type polyester is a polyester of a low-molecular-weight polyhydric alcohol (Mn: 300 or less) and a polycarboxylic acid or an ester-forming derivative of the polycarboxylic acid [e.g. an acid anhydride, acid halide, or a low-molecular-weight alkyl(C1-C4 alkyl)ester].

Examples of the low-molecular-weight polyhydric alcohol include a divalent to octavalent or more valent aliphatic polyhydric alcohol having a hydroxyl equivalent weight of 30 or more and less than 150, and a divalent to octavalent or more valent phenol-low-mole alkylene oxide adduct having a hydroxyl equivalent weight of 30 or more and less than 150.

Preferable examples of the low-molecular-weight polyhydric alcohol usable for condensation-type polyester include ethylene glycol, propylene glycol, 1,4-butanediol, neopentyl glycol, 1,6-hexane glycol, low-mole EO or PO adducts of bisphenol A, and combinations of these.

Examples of the polycarboxylic acid or the ester-forming derivatives of the polycarboxylic acid, usable for the condensation-type polyester include aliphatic dicarboxylic acids (e.g. succinic acid, adipic acid, azelaic acid, sebacic acid, fumaric acid, maleic acid), alicyclic dicarboxylic acids (e.g. dimer acid), aromatic dicarboxylic acids (e.g. terephthalic acid, isophthalic acid, phthalic acid), trivalent or more polycarboxylic acids (e.g. trimellitic acid, pyromellitic acid), anhydrides of these (e.g. succinic anhydride, maleic anhydride, phthalic anhydride, trimellitic anhydride), acid halides of these (e.g. adipic acid dichloride), low-molecular-weight alkyl esters of these (e.g. dimethyl succinate, dimethyl phthalate), and combinations of these.

Examples of the condensation-type polyester include polyethylene adipate diol, polybutylene adipate diol, polyhexamethylene adipate diol, polyhexamethylene isophthalate diol, polyneopentyl adipate diol, polyethylene propylene adipate diol, polyethylene butylene adipate diol, polybutylene hexamethylene adipate diol, polydiethylene adipate diol, poly(polytetramethylene ether) adipate diol, poly(3-methyl pentylene adipate)diol, polyethylene azelate diol, polyethylene sebacate diol, polybutyleneazelate diol, polybutylenesebacate diol, and polyneopentyl terephthalate diol.

The polylactone polyol is a polyaddition product of a lactone to the low-molecular-weight polyhydric alcohol. Examples of the lactone include C4-C12 lactones, and specific examples include γ-butyrolactone, γ-valerolactone, and ε-caprolactone.

Examples of the polylactone polyol include polycaprolactone diols, polyvalerolactone diols, and polycaprolactone triols.

The polycarbonate polyol is a polyaddition product of alkylenecarbonate to a law-molecular-weight polyhydric alcohol. Examples of the alkylenecarbonate include C2-C8 alkylenecarbonates, and specific examples include ethylene carbonate and propylene carbonate.

Examples of the polycarbonate polyol include polyhexamethylene carbonate diol.

Commercial products of the polycarbonate polyol include Nipporan 980R [Mn=2,000, product of Nippon Polyurethane Industry Co., Ltd.], T5652 [Mn=2,000, product of Asahi Kasei Corp.], and T4672 [Mn=2,000, product of Asahi Kasei Corp.].

The castor oil-based polyol include castor oil and polyol or alkylene oxide-modified castor oil. The modified castor oil is obtainable by transesterification between castor oil and a polyol, and/or addition reaction of an alkylene oxide. Examples of the castor oil-based polyol include castor oil, trimethylol propane-modified castor oil, pentaerythritol-modified castor oil, and castor oil EO (4 to 30 mol) adducts.

Examples of the low-molecular-weight polyol having a hydroxyl equivalent weight of less than 150 include divalent aliphatic alcohols (e.g. ethylene glycol, propylene glycol, 1,4-butanediol, neopentyl glycol, 1,6-hexanediol), and trivalent aliphatic alcohols (e.g. trimethylol propane, glycerin).

Any of these polyols may be used alone, or two or more of these may be used in combination.

Examples of the chain extender include water, C2-C10 diamines (e.g. ethylene diamine, propylene diamine, hexamethylene diamine, isophorone diamine, toluene diamine, piperazine), polyalkylene polyamines (e.g. diethylene triamine and triethylene tetramine), hydrazine or derivatives of hydrazine (such as acid hydrazide) (e.g. dibasic acid dihydrazides such as adipic acid dihydrazide), and C2-C10 amino alcohols (e.g. ethanol amine, diethanolamine, 2-amino-2-methyl propanol, triethanol amine).

Any of these chain extenders may be used alone, or two or more of these may be used in combination.

Examples of the organic polyisocyanate component (n) include C6-C20 (not counting the carbon atoms included in the isocyanate groups, the same shall apply hereinafter) aromatic polyisocyanates containing 2 to 3 or more isocyanate groups, C2-C18 aliphatic polyisocyanate, C4-C15 alicyclic polyisocyanates, and C8-C15 araliphatic polyisocyanates.

Examples of the aromatic polyisocyanate include 1,3- or 1,4-phenylene diisocyanate, 2,4- or 2,6-tolylene diisocyanate, 4,4′- or 2,4′-diphenylmethane diisocyanate, 1,5-naphthylene diisocyanate, 4,4′,4″-triphenylmethane triisocyanate, and m- or p-isocyanato phenylsulfonyl isocyanate.

Examples of the aliphatic polyisocyanate include ethylene diisocyanate, tetramethylene diisocyanate, hexamethylene diisocyanate, dodecamethylene diisocyanate, 2,2,4-trimethyl hexamethylene diisocyanate, lysine diisocyanate, and 2-isocyanato ethyl-2,6-diisocyanato hexanoate.

Examples of the alicyclic polyisocyanate include isophorone diisocyanate, 4,4-dicyclohexyl methanediisocyanate, cyclohexylene diisocyanate, methyl cyclohexylene diisocyanate, bis(2-isocyanato ethyl)-4-cyclohexene-1,2-dicarboxylate, and 2,5- or 2,6-norbornane diisocyanate.

Examples of the araliphatic polyisocyanate include m- or p-xylylene diisocyanate, and α,α,α′,α′-tetramethyl xylylene diisocyanate.

Preferable among the polyisocyanates are isophorone diisocyanate, 4,4′-dicyclohexylmethane diisocyanate, hexamethylene diisocyanate, 2,4-tolylene diisocyanate, 2,6-tolylene diisocyanate, 2,4′-diphenylmethane diisocyanate, 4,4′-diphenylmethane diisocyanate, and 1,5-naphthalene diisocyanate, in terms of the surface hardness and adhesion.

Any of these organic polyisocyanate components (n) may be used alone, or two or more of these may be used in combination.

The urethane and/or urea group-containing (meth)acrylate (Df) is obtainable by a typical method, for example, by bulk reaction of an active hydrogen component (m) that essentially contains a hydroxyl group-containing (meth)acrylate with an organic polyisocyanate component (n); and alternatively by a reaction of an active hydrogen component (m) not containing hydroxyl group-containing (meth)acrylates with an organic polyisocyanate component (n) to produce an urethane/urea prepolymer having an isocyanate group at terminal, followed by a reaction of the resulting urethane/urea prepolymer with a hydroxyl group-containing (meth)acrylate.

The ratio of the active hydrogen equivalents of the active hydrogen component (m) to the isocyanate group equivalents of the organic polyisocyanate component (n) (active hydrogen equivalents/isocyanate group equivalents) is preferably 0.1 to 10, and particularly preferably 0.9 to 1.2. The reaction temperature is preferably 30 to 150° C., and more preferably 50 to 100° C. The termination of the reaction is confirmed by disappearance of absorbance of the isocyanate groups in infrared absorption spectrum (2250 cm⁻¹) or by determination of the concentration of the isocyanate groups by the method disclosed in JIS K 7301-1995.

In selecting the combination [3] of the radical polymerizable compounds (D1), the amount of the urethane and/or urea group-containing (meth)acrylate (Df) in the photosensitive composition of the present invention is preferably 0 to 90% by weight, more preferably 1 to 85% by weight, and particularly preferably 5 to 80% by weight, based on the weight of the photosensitive composition in terms of the surface hardness and adhesion.

The combination [4] of the radical polymerizable compounds (D1) includes a (meth)acrylate (Dg) having a cyclic ether skeleton and a C1-C24 alkyl group-containing alkyl(meth)acrylate (Dh). In addition, a (meth)acryl resin (E), which is a copolymer of at least two kinds of radical polymerizable monomers, is included in the resulting photosensitive composition.

In the combination [4] of the radical polymerizable compounds (D1), preferable examples of the (meth)acrylate (Dg) having a cyclic ether skeleton include C6-C30 compounds, and examples of the cyclic ether skeleton include an epoxy ring, oxetane ring, tetrahydrofuran ring, dioxolane ring, and dioxane ring.

As for specific examples of (Dg), examples of a (meth)acrylate (Dg 1) having an epoxy ring include glycidyl(meth)acrylate; examples of a (meth)acrylate (Dg 2) having an oxetane ring include (3-ethyl-3-oxetanyl)methyl (meth)acrylate; examples of a (meth)acrylate (Dg 3) having a tetrahydrofuran ring include tetrahydrofurfuryl(meth)acrylate and γ-caprolactone-modified tetrahydrofurfuryl(meth)acrylate; examples of a (meth)acrylate (Dg 4) having a dioxolane ring include a dioxane glycol di(meth)acrylate, (2-methyl-2-ethyl-1,3-dioxolan-4-yl)methyl (meth)acrylate, (2,2-cyclohexyl-1,3-dioxolan-4-yl)methyl (meth)acrylate, and dioxane glycol di(meth)acrylate; and examples of a (meth)acrylate (Dg 5) having a dioxane ring include (5-methyl-1,3-dioxane-5-yl)methyl (meth)acrylate. Any of these (Dg)s may be used alone, or two or more of these may be used in combination.

Preferable among these are the (meth)acrylate (Dg 3) having a tetrahydrofuran ring and the (meth)acrylate (Dg 4) having a dioxolane ring.

In selecting the combination [4] of the radical polymerizable compounds (D1), the amount of the (meth)acrylate (Dg) having a cyclic ether skeleton in the photosensitive composition of the present invention is preferably 1 to 90% by weight, and more preferably 10 to 80% by weight, based on the photosensitive composition in terms of the heat resistance and adhesion.

Examples of the C1-C24 alkyl group-containing alkyl(meth)acrylate (Dh) for the combination [4] of the radical polymerizable compounds (D1) include appropriated ones among the examples of the monofunctional (meth)acrylate in the (meth)acrylate composition (D12). Any of (Dh)s may be used alone, or two or more of these may be used in combination.

Preferable among these are C12-C24 alkyl group-containing alkyl(meth)acrylates.

In selecting the combination [4] of the radical polymerizable compounds (D1), the amount of the C12-C24 alkyl group-containing alkyl(meth)acrylate (Dh) in the photosensitive composition of the present invention is preferably 1 to 90% by weight, and more preferably 2 to 80% by weight, based on the weight of the photosensitive composition in terms of the heat resistance and adhesion.

In selecting the combination [4] of the radical polymerizable compounds (D1), the (meth)acryl resin (E) used for the photosensitive composition of the present invention is required to be a copolymer of at least two kinds of radical polymerizable monomers including alkyl(meth)acrylate, and preferably a copolymer of three or more kinds of radical polymerizable monomers, in terms of the heat resistance and adhesion.

Examples of the above radical polymerizable monomers include (meth)acrylic acid, C12-C24 alkyl(meth)acrylates, hydroxy alkyl(meth)acrylates containing a C1-C24 hydroxy alkyl group, glycidyl(meth)acrylate, acrylonitrile, acrylamide, styrene, and vinyl acetate.

Examples of the C1-C24 alkyl group-containing alkyl(meth)acrylate include those listed for the (Dh). Examples of the hydroxy alkyl(meth)acrylates containing a C1-C24 hydroxy alkyl group include appropriate ones among the listed monofunctional (meth)acrylates in the (meth)acrylate compound (D12).

Preferable as the (meth)acryl resin (E) is a (meth)acryl resin which is a copolymer of at least three kinds of the radical polymerizable monomers including vinyl acetate (in an amount of preferably 1 to 40 mol % of the total radical polymerizable monomers). Any of (E)s may be used alone, or two or more of these may be used in combination.

The Mn of the (meth)acryl resin (E) is preferably 10,000 to 1,000,000, and more preferably 20,000 to 800,000.

The Mn of the (meth)acryl resin (E) of the present invention is measured in the following conditions:

Apparatus: gel permeation chromatography system

Solvent: tetrahydrofuran

Standard substance: polystyrene

Sample concentration: 3 mg/ml

Column stationary phase: PLgel MIXED-B

Column temperature: 40° C.

In selecting the combination [4] of the radical polymerizable compounds (D1), the amount of the (meth)acryl resin (E) in the photosensitive composition of the present invention is preferably 1 to 80% by weight, and more preferably 2 to 60% by weight, based on the weight of the photosensitive composition in terms of the heat resistance and adhesion.

The photosensitive composition of the present invention should contain substantially no colorants (e.g. inorganic and organic pigments, dyes), metal oxides, or metallic powders, which are all coloring materials, in terms of the transparency of the resulting cured article. Here, the term “contain substantially no” means that the amount in the photosensitive composition is less than 1% by weight. The amount of the coloring material(s) in the photosensitive composition is preferably 0.8% by weight or less, and more preferably 0% by weight.

The photosensitive composition of the present invention may optionally contain solvent(s), sensitizer(s), tackifier(s) (e.g. silane coupling agent), and the like.

Examples of solvents include glycol ethers (e.g. ethylene glycol monoalkyl ethers, propylene glycol monoalkyl ethers), ketones (e.g. acetone, methyl ethyl ketone, methyl isobutyl ketone, cyclo hexanon), esters (e.g. ethyl acetate, butyl acetate, ethylene glycol alkyl ether acetates, propylene glycol alkyl ether acetates), aromatic hydrocarbons (e.g. toluene, xylene, mesitylene), alcohols (e.g. methanol, ethanol, normal propanol, isopropanol, butanol, geraniol, linalool, citronellol), and ethers (e.g. tetrahydrofuran, 1,8-cineole). Any of these may be used alone, or two or more of these may be used in combination.

The solvent content of the photosensitive composition is preferably 0 to 99% by weight, more preferably 3 to 95% by weight, and particularly preferably 5 to 90% by weight.

Examples of sensitizers include ones other than (C) among ketocumarin, fluorene, thioxanthone, anthraquinone, naphthiazoline, biacetyl, benzyl, derivatives of these, perylene, and substituted anthracene. The amount of sensitizer(s) is preferably 0 to 20% by weight, more preferably 1 to 15% by weight, and particularly preferably 2 to 10% by weight, based on the weight of the photosensitive composition.

Examples of tackifiers include γ-aminopropyltrimethoxysilane, γ-aminopropyltriethoxysilane, vinyltriethoxysilane, γ-glycidoxypropyltriethoxysilane, γ-methacryloxypropyltrimethoxysilane, urea propyltriethoxysilane, tris(acetyl acetonato)aluminum, and acetyl acetate aluminum diisopropylate. The amount of tackifier(s) is preferably 0 to 20% by weight, more preferably 1 to 15% by weight, and particularly preferably 2 to 10% by weight, based on the weight of the photosensitive composition.

The photosensitive composition of the present invention may further contain dispersing agent(s), antifoamer(s), leveling agent(s), thixotropy imparting agent(s), slip additive(s), flame retardant(s), antistatic agent(s), antioxidant(s), ultraviolet absorber(s), and the like, in accordance with the purpose of its usage.

The photosensitive composition of the present invention can be prepared by kneading the radical initiator (A); the polymerizable substance (D); and the acid generator (B) and/or the base generator (C); and optionally solvent(s) and other materials together using a ball mill or three roll mills. The kneading temperature is commonly 10° C. to 40° C., and is preferably 20° C. to 30° C.

Since the photosensitive composition of the present invention can be photocured by exposure to active rays of 360 to 830 nm, the following lamps in addition to common high-pressure mercury lamps are usable: ultra-high-pressure mercury lamps, metal halide lamps, high-power metal halide lamps (Latest trend of UV-EB curing technique, edited by RadTech Japan, CMC Publishing Co., Ltd., page 138, 2006), and the like. Irradiators equipped with an LED light source are also suitably used. Heating treatment may be carried out during and/or after active ray irradiation so as to diffuse a base generated from the photobase generator. In this case, the heating temperature is commonly 30° C. to 200° C., and is preferably 35° C. to 150° C., and more preferably 40° C. to 120° C.

The photosensitive composition of the present invention can be applied to a substrate by known coating methods such as spin coating, roll coating, and spray coating, or known printing methods such as lithography, carton printing, metal printing, offset printing, silk screening, and gravure printing. The composition may be applied by inkjet methods in which tiny droplets are continuously discharged.

### EXAMPLES

The following examples illustrate the present invention in more detail. They are, however, by no means limitative of the scope of the invention. All percentages and parts used below are by weight unless otherwise specified.

### [Production of Acid Generator (B)]

### Preparation 1

### [Synthesis of Acid Generator (B121-1) {Compound Represented by Formula (41)}]

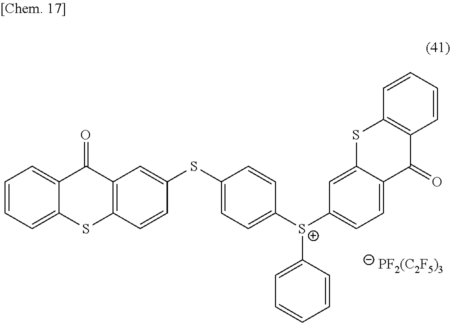

### (1) Synthesis of 2-(phenylthio)thioxanthone [intermediate (B121-1-1)]

2-Chlorothioxanthone (11.0 parts), thiophenol (4.9 parts), potassium hydroxide (2.5 parts), and N,N-dimethyl formamide (162 parts) were homogeneously mixed and allowed to react at 130° C. for nine hours. Subsequently, the resulting reaction mixture was cooled to room temperature (about 25° C.) and added to distilled water (200 parts) to give precipitates of the reaction product. The resulting mixture was then filtered, and the residue was washed with water until the pH of the filtrate became neutral. The residue was then dried under reduced pressure. As a result, a yellow powdery product was obtained. After purification by column chromatography (eluent: toluene/hexane=1/1 (volume ratio)), 3.1 parts of an intermediate (B121-1-1) was obtained (as yellow solids).

### (2) Synthesis of 2-[(phenyl)sulfinyl]thioxanthone [intermediate (B121-1-2)]

A 30% hydrogen peroxide aqueous solution (4.0 parts) was gradually added dropwise to a mixture of the intermediate (B121-1-1) (11.2 parts), acetonitrile (215 parts), and sulfuric acid (0.02 parts) with stirring at 40° C. The mixture was allowed to react at 40° C. to 45° C. for 14 hours, cooled to room temperature (about 25° C.), and added to distilled water (200 parts) to give precipitates of the reaction product. The resulting mixture was then filtered, and the residue was washed with water until the pH of the filtrate became neutral. The residue was then dried under reduced pressure, and a yellow powdery product was obtained. The product was subjected to purification by column chromatography (eluent: ethyl acetate/toluene=1/3 (volume ratio)) to give 13.2 parts of an intermediate (B121-1-2) (as yellow solids).

### (3) Synthesis of Acid Generator (B121-1)

Trifluoromethanesulfonic acid (2.4 parts) was gradually added dropwise to a mixture of the intermediate (B121-1-2) (4.3 parts), acetic anhydride (4.1 parts), and acetonitrile (110 parts) with stirring at 40° C. The mixture was allowed to react at 40° C. to 45° C. for one hour. The reaction mixture was cooled to room temperature (about 25° C.), and added to distilled water (150 parts). The resulting mixture was extracted with chloroform and washed with water until the pH of the aqueous phase became neutral. The chloroform phase was transferred into a rotary evaporator, and the solvent was removed. Subsequently, the resulting product was dispersed in toluene (50 parts) by an ultrasonic cleaner. The dispersant was allowed to stand for about 15 minutes, and then the supernatant was removed. After repeating these procedures three times, the recovered solids were washed, and the residue was dried under reduced pressure. The residue was then dissolved in dichloromethane (212 parts), and the solution was added to a 10% potassium tris(pentafluoroethyl)trifluorophosphate aqueous solution (65 parts). The resulting mixture was stirred at room temperature (about 25° C.) for two hours. The dichloromethane phase was separated by washing with water three times, and the organic solvent was evaporated under reduced pressure. As a result, 5.5 parts of an acid generator (B121-1) was obtained (as yellow solids).

### Preparation 2

### [Synthesis of Acid Generator (B121-2) {Compound Represented by Formula (42)}]

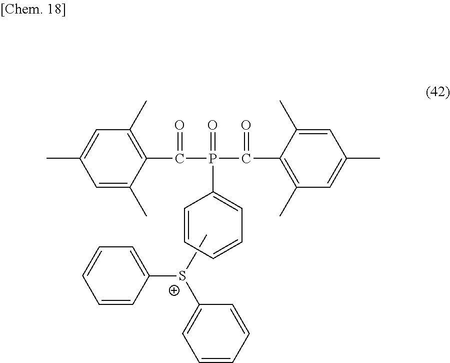

IRGACURE 819 [product of BASF] (4.2 parts), p-tolyl sulfoxide [product of Tokyo Chemical Industry Co., Ltd.] (2.8 parts), potassium nonafluoro-1-butane sulfonate [product of Tokyo Chemical Industry Co., Ltd.] (4.1 parts), sulfuric acid [product of Wako Pure Chemical Industries, Ltd.] (1.2 parts), and acetonitrile (100 parts) were dissolved in a reaction vessel, and the solution was stirred at 60° C. for six hours. Dichloromethane (200 parts) was added, and the organic phase was washed with ion exchange water (200 parts) three times, and then subjected to vacuum distillation to remove the solvent. As a result, 6.7 parts of an acid generator (B121-2) was obtained (as yellow solids).

### Preparation 3

### [Synthesis of Acid Generator (B121-3) {Compound Represented by Formula (43)}]

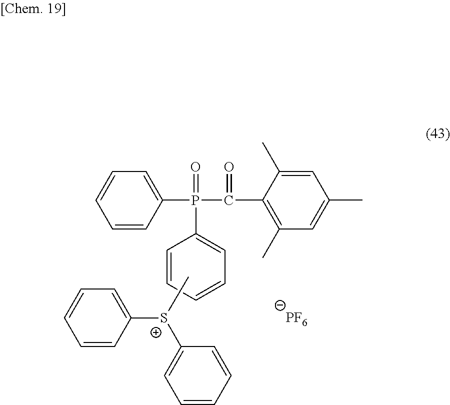

LUCIRIN TPO [product of BASF] (3.5 parts), diphenyl sulfoxide [product of Tokyo Chemical Industry Co., Ltd.] (2.4 parts), potassium hexafluorophosphate [product of Tokyo Chemical Industry Co., Ltd.] (2.2 parts), sulfuric acid [product of Wako Pure Chemical Industries, Ltd.] (1.2 parts), and acetonitrile (100 parts) were dissolved in a reaction vessel, and the solution was stirred at 60° C. for six hours. Dichloromethane (200 parts) was added, and the organic phase was washed with ion exchange water (200 parts) three times, and then subjected to vacuum distillation to remove the solvent. As a result, 5.4 parts of an acid generator (B121-3) was obtained (as yellow solids).

### Preparation 4

[Synthesis of Acid Generator (B121-4) {Compound Represented by Formula (44)}]

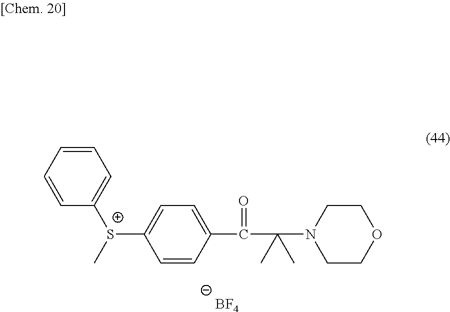

IRGACURE 907 [product of BASF] (2.8 parts), bromo benzene [product of Tokyo Chemical Industry Co., Ltd.] (1.7 parts), silver tetrafluoroborate [product of Tokyo Chemical Industry Co., Ltd.] (2.3 parts), and tetrahydrofuran (100 parts) were dissolved in a reaction vessel, and the solution was stirred at 60° C. for six hours. Dichloromethane (200 parts) was added, and the organic phase was washed with ion exchange water (200 parts) three times, and then subjected to vacuum distillation to remove the solvent. As a result, 3.3 parts of an acid generator (B121-4) was obtained (as pale yellow solids).

### Preparation 5

### [Synthesis of Acid Generator (B122-1) {Compound Represented by Formula (45)}]

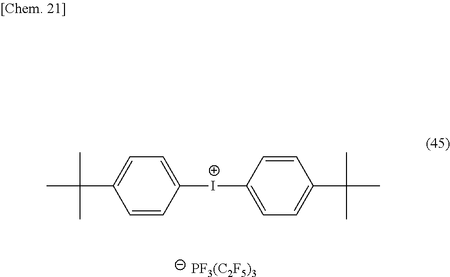

t-Butyl benzene [product of Tokyo Chemical Industry Co., Ltd.] (8.1 parts), potassium iodide [product of Tokyo Chemical Industry Co., Ltd.] (5.35 parts), and acetic anhydrides (20 parts) were dissolved in acetic acid (70 parts), and the solution was cooled to 10° C. The mixed solution of strong sulfuric acid (12 parts) and acetic acid (15 parts) was added dropwise over one hour, while the temperature was controlled to 10° C.±2° C. After the temperature was elevated to 25° C., the solution was stirred for 24 hours. Subsequently, diethyl ether (50 parts) was added to the obtained reaction mixture. The resulting mixture was washed with water three times, and diethyl ether was evaporated under reduced pressure. The residue was added to an aqueous solution of potassium {trifluoro[tris(perfluoroethyl)]phosphate} (118 parts dissolved in 100 parts of water). After stirring at 25° C. for 20 hours, the reaction mixture was mixed with ethyl acetate (500 parts) and washed with water three times. The organic solvents were evaporated under reduced pressure to afford 14.0 parts of a target acid generator (B122-1) (as a pale yellow liquid).

### Preparation 6

[Synthesis of Acid Generator (B122-2) {Compound Represented by formula (46)}]

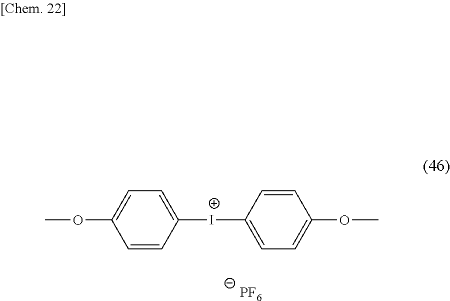

The same procedures were used as in Preparation 5, except that “t-butyl benzene (8.1 parts)” and “potassium{trifluoro[tris(perfluoroethyl)]phosphate} (118 parts)” were changed to “methoxy benzene [product of Tokyo Chemical Industry Co., Ltd.] (7.5 parts)” and “potassium hexafluoro phosphate [product of Tokyo Chemical Industry Co., Ltd.] (80 parts)”, respectively. As a result, 12.1 parts of an acid generator (B122-2) was obtained (as a pale yellow liquid).

### Preparation 7

### [Synthesis of Acid Generator (B122-3) {Compound Represented by Formula (47)}]

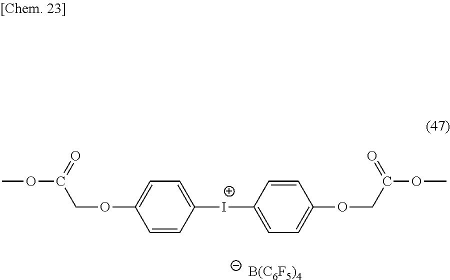

The same procedures were used as in Preparation 5, except that “t-butyl benzene (8.1 parts)” and “potassium {trifluoro[tris(perfluoroethyl)]phosphate} (118 parts)” were changed to “methyl phenoxy acetate [product of Tokyo Chemical Industry Co., Ltd.] (9.2 parts)” and “potassium tetrakis(perfluorophenyl)borate [product of Tokyo Chemical Industry Co., Ltd.] (140 parts)”, respectively. As a result, 13.3 parts of an acid generator (B122-3) was obtained (as a pale yellow liquid).

### Preparation 8

### [Synthesis of Acid Generator (B122-4) {Compound Represented by Formula (48)}]

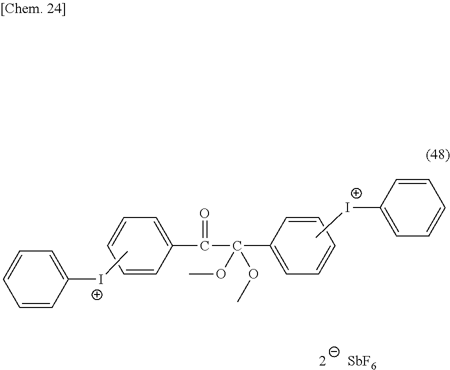

IRGACURE 651 [product of BASF] (2.4 parts), potassium iodide [product of Tokyo Chemical Industry Co., Ltd.] (4.0 parts), silver hexafluoroantimonate [product of Tokyo Chemical Industry Co., Ltd.] (8.2 parts), sulfuric acid [product of Wako Pure Chemical Industries, Ltd.] (2.4 parts), benzene (5.0 parts), and acetonitrile (100 parts) were dissolved in a reaction vessel, and the solution was stirred at 60° C. for six hours. Dichloromethane (200 parts) was added thereto, the organic phase was washed with ion exchange water (200 parts) three times, and the organic solvent was removed by vacuum distillation. As a result, 10.7 parts of an acid generator (B122-4) was obtained (as pale yellow solids).

### Preparation 9

### [Synthesis of Acid Generator (B122-5) {Compound Represented by Formula (49)}]

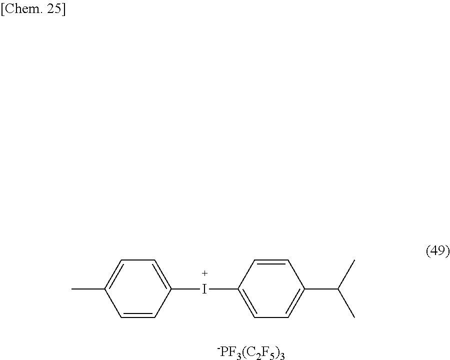

The same procedures were used as in Preparation 5, except that “t-butyl benzene (8.1 parts)” was changed to “toluene [product of Tokyo Chemical Industry Co., Ltd.] (6.5 parts)” and “isopropyl benzene [product of Tokyo Chemical Industry Co., Ltd.] (8.1 parts)”. As a result, 5.0 parts of an acid generator (B122-5) was obtained (as a pale yellow liquid).

### [Preparation of Base Generator (C)]

### Preparation 10

### [Synthesis of Base Generator (C122-1) {Compound Represented by Formula (50)}]

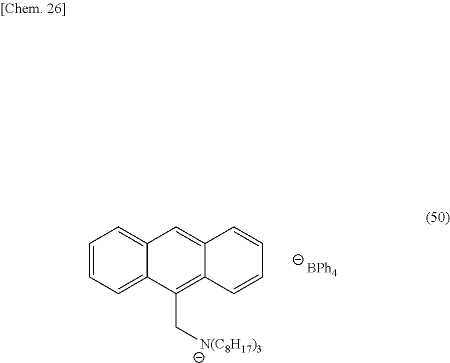

9-Chloromethyl anthracene (product of Aldrich) (2.0 parts) was dissolved in chloroform. To this solution were added small portions of trioctyl amine [product of Wako Pure Chemical Industries, Ltd.] (3.1 parts) (a small exotherm was observed after the addition). The mixture was then stirred at room temperature (about 25° C.) for one hour. The resulting reaction mixture was added dropwise in small portions to an aqueous solution containing sodium tetraphenyl borate (4.0 parts) and water (40 parts), and the mixture was stirred at room temperature (about 25° C.) for one hour. The aqueous phase was removed by a separation operation. The organic phase was washed with water three times, and the organic solvent was evaporated under reduced pressure. As a result, 7.1 parts of white solids were obtained. The white solids were recrystallized in acetonitrile, and 6.2 parts of a base generator (C122-1) was obtained (as white solids).

### Preparation 11

### [Synthesis of Base Generator (C122-2) {Compound Represented by Formula (51)}]

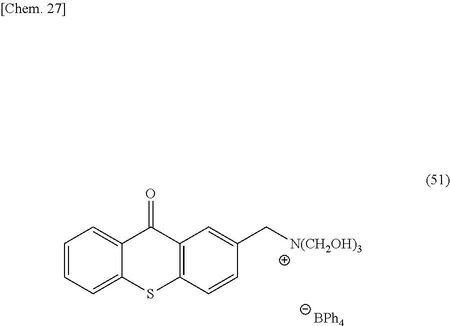

### (1) Synthesis of Methylthioxanthone [Intermediate (C122-2-1)]

Dithiosalicylic acid [product of Wako Pure Chemical Industries, Ltd.] (10 parts) was dissolved in sulfuric acid (139 parts), and the solution was stirred at room temperature (about 25° C.) for one hour and then cooled in an ice bath. Toluene (25 parts) was added dropwise in small portions to the cooled solution, while the temperature of the cooled solution was controlled to 20° C. or lower. Thereafter, the temperature was recovered to room temperature (about 25° C.), and the solution was further stirred for two hours. The resulting reaction mixture was added in small portions to water (815 parts), and precipitated yellow solids were filtered. The yellow solids were dissolved in dichloromethane (260 parts). To the resulting solution, water (150 parts) was added, and then 24% KOH aqueous solution (6.7 parts) was added to alkalinize the aqueous phase. After stirring the resulting mixture for one hour, the aqueous phase was removed by a separation operation, and the organic phase was washed with water (130 parts) three times. Then, the organic phase was dried over anhydrous sodium sulfate, and the organic solvent was evaporated under reduced pressure. As a result, 8.7 parts of an intermediate (C122-2-1) was obtained (as yellow solids). The intermediate (C122-2-1) was a mixture of 2-methylthioxanthone and 3-methylthioxanthone.

### (2) Synthesis of 2-bromomethylthioxanthone [intermediate (C122-2-2)]

The intermediate (C122-2-1) (2.1 parts) was dissolved in cyclohexane (120 parts), and N-bromosuccinimide [product of Wako Pure Chemical Industries, Ltd.] (8.3 parts) and benzoyl peroxide [product of Wako Pure Chemical Industries, Ltd.] (0.1 parts) were added to this solution. The resulting mixture was allowed to react under reflux for four hours (3-methylthioxanthone remained unreacted), and then the solvent (cyclohexane) was removed. The residue was redissolved in chloroform (50 parts), and this chloroform solution was washed with water (30 parts) three times. After the aqueous phase was removed by a separation operation, the organic solvent was evaporated under reduced pressure. As a result, 1.7 parts of brown solids were obtained. The solids were recrystallized in ethyl acetate (3-methylthioxanthone was separated in this step), and 1.5 parts of an intermediate (C122-2-2) was obtained (as yellow solids).

### (3) Synthesis of N-(9-oxo-9H-thioxanthene-2-yl)methyl-N,N,N-tris(2-hydroxyethyl) ammonium bromide [intermediate (C122-2-3)]

The intermediate (C122-2-2) (2-bromomethylthioxanthone) (1.0 part) was dissolved in dichloromethane (85 g), and triethanol amine [product of Wako Pure Chemical Industries, Ltd.] (0.5 parts) was added dropwise to this solution (an exotherm was observed after the addition). The resulting mixture was stirred at room temperature (about 25° C.) for one hour, and the organic solvent was evaporated under reduced pressure. As a result, 2.2 parts of white solids were obtained. The white solids were recrystallized in a tetrahydrofuran/dichloromethane mixed solution, and 1.0 part of an intermediate (C122-2-3) was obtained (as brown solids).

### (4) Synthesis of Base Generator (C122-2)

A solution of the intermediate (C122-2-3) (1.0 part dissolved in 50 parts of chloroform) was prepared beforehand and added dropwise in small portions to an aqueous solution of sodium tetraphenyl borate [product of Nacalai Tesque, Inc.](0.8 parts dissolved in 17 parts of water). The resulting mixture was stirred at room temperature (about 25° C.) for one hour. The aqueous phase was removed by a separation operation, and the organic phase was washed with water (30 parts) three times. The organic solvent was evaporated under reduced pressure to afford yellow solids. The yellow solids were recrystallized in an acetonitrile/ether mixed solution, and 1.3 parts of a base generator (C122-2) was obtained (as a fine yellow powder).

### Preparation 12

### [Synthesis of Base Generator (C122-3) {Compound Represented by Formula (52)}]

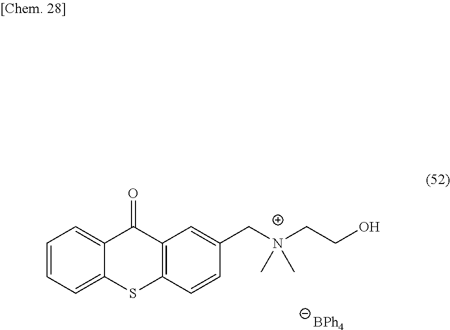

### (1) Synthesis of N-(9-oxo-9H-thioxanthene-2-yl)methyl-N,N-dimethyl-N-(2-hydroxyethyl)ammonium bromide [intermediate (C122-3-3)]

The same procedures as in (1) to (3) of Preparation 11 were used, except that “triethanol amine [product of Wako Pure Chemical Industries, Ltd.] (0.5 parts)” was changed to “dimethylethanol amine [product of Wako Pure Chemical Industries, Ltd.] (0.3 parts)”. As a result, 0.8 parts of an intermediate (C122-3-3) was obtained (as brown solids).

### (2) Synthesis of Base Generator (C122-3)

The same procedures as in (4) of Preparation 11 were used, except that “the intermediate (C122-2-3) (1.0 part)” was changed to “the intermediate (C122-3-3) (0.8 parts)”. As a result, 1.0 part of a base generator (C122-3) was obtained (as a white powder).

### Preparation 13

### [Synthesis of Base Generator (C122-4) {Compound Represented by Formula (53)}]

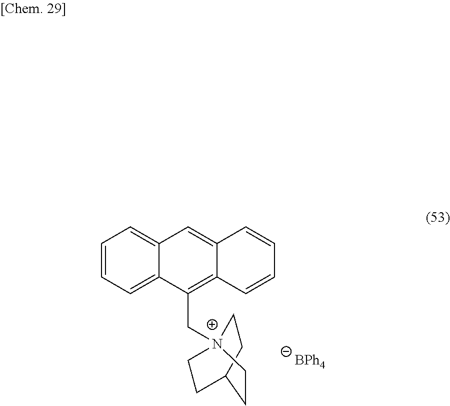 [SMILES: c1ccc2c(C[N+]34CCC(CC3)CC4)c3ccccc3cc2c1 ; "BPh4"]

The same procedures as in Preparation 10 were used, except that “trioctyl amine [product of Wako Pure Chemical Industries, Ltd.] (3.1 parts)” was changed to “1-azabicyclo[2.2.2]octane (1.0 part)”. As a result, 4.4 parts of a base generator (C122-4) was obtained (as white solids).

### Preparation 14

### [Synthesis of Base Generator (C123-1) {Compound Represented by Formula (54)}]

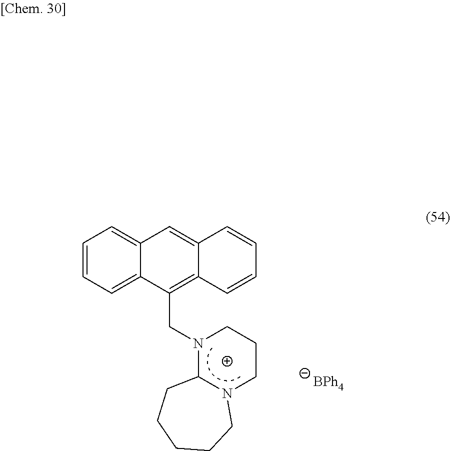 [SMILES: c1ccc2c(CN3CCCN4CCCCCC43)c3ccccc3cc2c1 ; "BPh4"]

The same procedures as in Preparation 10 were used, except that “trioctyl amine [product of Wako Pure Chemical Industries, Ltd.] (3.1 parts)” was changed to “1,8-diazabicyclo[5.4.0]-7-undecene [“DBU” by San-Apro Ltd.] (1.3 parts)”. As a result, 4.7 parts of a base generator (C123-1) was obtained (as white solids).

### Preparation 15

### [Synthesis of Base Generator (C123-2) {Compound Represented by Formula (55)}]

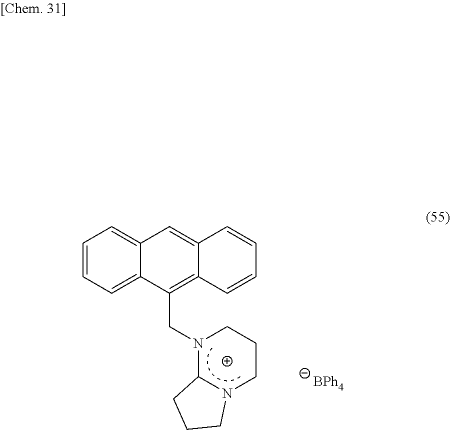 [SMILES: c1ccc2c(CN3CCCN4CCCC43)c3ccccc3cc2c1 ; "BPh4"]

The same procedures as in Preparation 10 were used, except that “trioctyl amine [product of Wako Pure Chemical Industries, Ltd.] (3.1 parts)” was changed to “1,5-diazabicyclo[4.3.0]-5-nonene [“DBN” by San-Apro Ltd.] (1.1 parts)”. As a result, 4.6 parts of a base generator (C123-2) was obtained (as white solids).

### Preparation 16

### [Synthesis of Base Generator (C123-3) {Compound Represented by Formula (56)}]

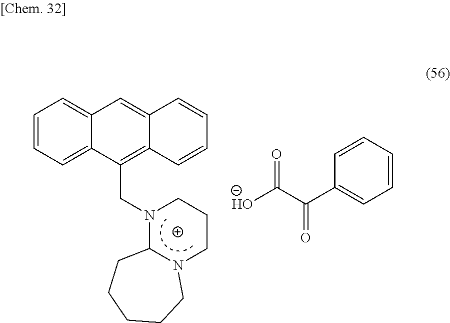 [SMILES: c1ccc2c(CN3CCCN4CCCCCC43)c3ccccc3cc2c1 ; O=C([O-])C(=O)c1ccccc1]

### (1) Preparation of Silver Phenylglyoxylate:

Phenylglyoxylic acid (product of Aldrich) (3.9 parts) was dissolved in methanol (20 parts), and sodium hydroxide [product of Wako Pure Chemical Industries, Ltd.] (0.9 parts) was added in small portions to this solution (the neutralization was exothermic). The resulting mixture was stirred for one hour, and a 1 mol/L silver nitrate aqueous solution [product of Wako Pure Chemical Industries, Ltd.] (10.4 parts) was added thereto. Precipitated grey solids were filtered, washed with methanol and dried. As a result, 4.4 parts of silver phenyl glyoxylate was obtained (as gray solids).

### (2) Synthesis of Base Generator (C123-3):

9-Chloromethylanthracene (product of Aldrich) (2.0 parts) was dissolved in methanol (40 g), and 1,8-diazabicyclo[5.4.0]-7-undecene [“DBU” by San-Apro Ltd.] (1.3 parts) was added in small portions to this solution (an exotherm was observed after the addition). The resulting mixture was stirred at room temperature (about 25° C.) for one hour. The resulting reaction mixture was added dropwise in small portions to a dispersant containing silver phenylglyoxylate (3.0 parts) and methanol (20 parts), and the mixture was stirred at room temperature (about 25° C.) for one hour. Grey solids generated therein were removed by filtration, and the filtrate was evaporated under reduced pressure. As a result, 4.5 parts of brown solids were obtained. The brown solids were recrystallized in an ether/hexane mixed solution, and 2.6 parts of a base generator (C123-3) was obtained (as yellow solids).

### Preparation 17

### [Synthesis of Base Generator (C123-4) {Compound Represented by Formula (57)}]

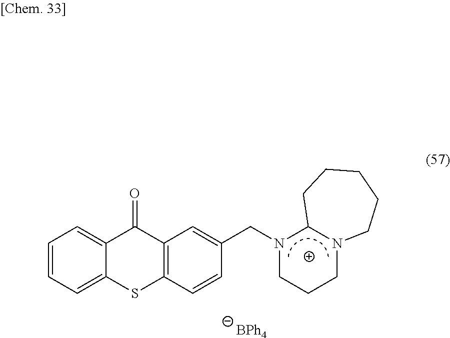 [SMILES: O=c1c2ccccc2sc2ccc(CN3CCCN4CCCCCC43)cc12 ; "BPh4"]

### (1) Synthesis of 8-(9-oxo-9H-thioxanthene-2-yl)methyl-1,8-diazabicyclo[5.4.0]-7-undecenium bromide [intermediate (C123-4-3)]

The same procedures as in (1) to (3) of Preparation 11 were used, except that “triethanol amine [product of Wako Pure Chemical Industries, Ltd.]” was changed to “1,8-diazabicyclo[5.4.0]-7-undecene [“DBU” by San-Apro Ltd.]”. As a result, 2.2 parts of an intermediate (C123-4-3) was obtained (as white solids).

### (2) Synthesis of Base Generator (C123-4)

The same procedures as in (4) of Preparation 11 were used, except that “the intermediate (C122-2-3)” was changed to “the intermediate (C123-4-3)”. As a result, 1.3 parts of a base generator (C123-4) was obtained (as a pale white yellow powder).

### Preparation 18

### [Synthesis of Base Generator (C123-5) {Compound Represented by Formula (58)}]

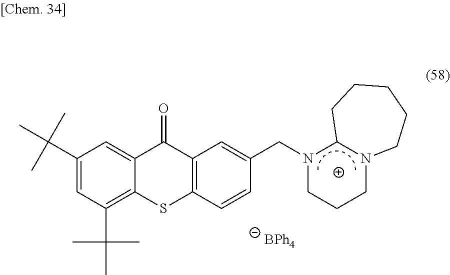 [SMILES: CC(C)(C)c1cc(C(C)(C)C)c2sc3ccc(CN4CCCN5CCCCCC54)cc3c(=O)c2c1]

### (1) Synthesis of 2,4-di-tert-butyl-7-methylthioxanthone [intermediate (C123-5-1)]

The intermediate (C122-2-1) (2.1 parts) was dissolved in dichloromethane (85 parts), and aluminum (III) chloride [product of Wako Pure Chemical Industries, Ltd.] (0.5 parts) and 2-chloro-2-methylpropane [product of Wako Pure Chemical Industries, Ltd.] (1.9 parts) were added to this solution. The resulting mixture was stirred at room temperature (about 25° C.) for 23 hours. The aqueous phase was removed by a separation operation, and the organic phase was washed with water (30 parts) three times. The organic solvent was evaporated under reduced pressure to afford pale yellow solids. The pale yellow solids were recrystallized in an ethyl acetate/hexane mixed solution, and 0.5 parts of an intermediate (C123-5-1) was obtained (as a yellow powder).

### (2) Synthesis of 2,4-di-tert-butyl-7-bromomethylthioxanthone [intermediate (C123-5-2)]

The same procedures as in (2) of Preparation 11 were used, except that “the intermediate (C122-2-1) (2.1 parts)” was changed to “the intermediate (C123-5-1) (1.0 part)”. As a result, 1.2 parts of an intermediate (C123-5-2) was obtained (as a yellow powder).

### (3) Synthesis of 8-(2,4-di-tert-butyl-9-oxo-9H-thioxanthene-7-yl)methyl-1,8-diazabicyclo[5.4.0]-7-undecenium bromide [intermediate (C123-5-3)]

The same procedures as in (3) of Preparation 11 were used, except that “the intermediate (C122-2-2)” was changed to “the intermediate (C123-5-2)”. As a result, 1.3 parts of an intermediate (C123-5-3) was obtained (as a fine yellow powder).

### (4) Synthesis of Base Generator (C123-5)

The same procedures as in (4) of Preparation 11 were used, except that “the intermediate (C122-2-2) (1.0 part)” was changed to “the intermediate (C123-5-3) (0.8 parts).” As a result, 1.0 part of a base generator (C123-5) was obtained (as a fine yellow powder).

### Preparation 19

### [Synthesis of Base Generator (C123-6) {Compound Represented by Formula (59)}]

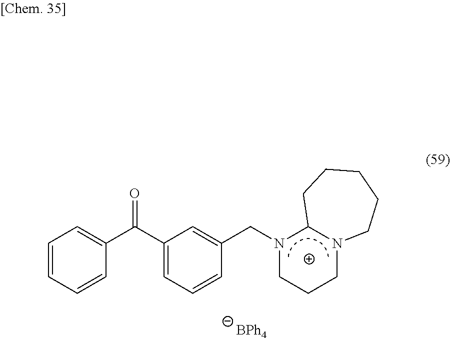 [SMILES: O=C(c1ccccc1)c1cccc(CN2CCCN3CCCCCC32)c1 ; "BPh4"]

### (1) Synthesis of 4-bromomethyl benzophenone [intermediate (C123-6-1)]

4-Methyl benzophenone (product of Aldrich) (25.1 parts), N-bromo succinimide [product of Wako Pure Chemical Industries, Ltd.] (22.8 parts), benzoyl peroxide [water content: 20% by Wako Pure Chemical Industries, Ltd.] (0.54 parts), and acetonitrile (80 parts) were mixed, heated to 80° C., and allowed to react for 2 hours under reflux. Subsequently, the resulting mixture was cooled, and the organic solvent was evaporated under reduced pressure. The residue was recrystallized in methanol (160 parts). As a result, 26 parts of an intermediate (C123-6-1) was obtained (as white crystals).

### (2) Synthesis of 8-(4-benzoylphenyl)methyl-1,8-diazabicyclo[5.4.0]-7-undecenium bromide [intermediate (C123-6-2)]

The intermediate (C123-6-1) (25.8 parts) was dissolved in acetonitrile (100 parts), and 1,8-diazabicyclo[5.4.0]-7-undecene [“DBU” by San-Apro Ltd.] (14.6 parts) was added dropwise to this solution (an exotherm was observed after the addition). The resulting mixture was stirred at room temperature (about 25° C.) for 18 hours, and the organic solvent was evaporated under reduced pressure. As a result, brown solids were obtained. The brown solids were recrystallized in acetonitrile, and 28.2 parts of an intermediate (C123-6-2) was obtained (as white solids).

### (3) Synthesis of Base Generator (C123-6)

A solution of the intermediate (C123-6-2) (6.8 parts dissolved in 50 parts of chloroform) was prepared beforehand and added dropwise in small portions to a solution of sodium tetraphenyl borate [product of Nacalai Tesque, Inc.] (0.8 parts dissolved in 17 parts of water). The resulting mixture was stirred at room temperature (about 25° C.) for two hours. The resulting reaction mixture was filtered, and the filtrate was evaporated under reduced pressure to afford a yellow liquid. The yellow liquid was dissolved and recrystallized in acetonitrile. As a result, 7.6 parts of a base generator (C123-6) was obtained (as white solids).

### Preparation 20

### [Synthesis of Base Generator (C123-7) {Compound Represented by Formula (60)}]

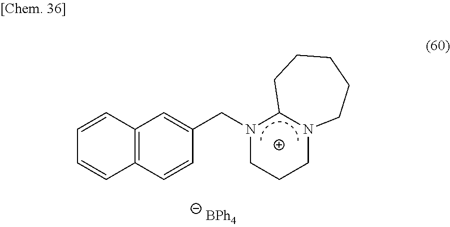 [SMILES: c1ccc2cc(CN3CCCN4CCCCCC43)ccc2c1]

### (1) Synthesis of 8-(9-naphthalylmethyl)-1,8-diazabicyclo[5.4.0]-7-undecenium bromide [(C123-7-1)]

The same procedures as in (2) of Preparation 19 were used, except that “the intermediate (C123-6-1) (25.8 parts)” was changed to “2-bromomethyl naphthalene [product of Tokyo Chemical Industry Co., Ltd.] (1.1 parts)”. As a result, 1.3 parts of an intermediate (C123-7-1) was obtained (as a white powder).

### (2) Synthesis of Base Generator (C123-7)

The same procedures as in (3) of Preparation 19 were used, except that “the intermediate (C123-6-2) (6.8 parts)” was changed to “the intermediate (C123-7-1) (0.8 parts)”. As a result, 1.3 parts of a base generator (C123-7) was obtained (as a fine yellow powder).

### Examples 1 to 22

### Radical Polymerization

Photosensitive compositions (Q-1) to (Q-22) of the present invention were prepared by kneading dipentaerythritol pentaacrylate [“neomer DA-600” by Sanyo Chemical Industries, Ltd.] (96.5 parts) as a radical polymerizable compound, together with a radical initiator (A) and acid generator(s) (B) or base generator(s) (C) shown in Table 1, using a ball mill at 25° C. for three hours. The amount of a radical initiator (A) was 3 parts and the amount of acid generator(s) (B) or base generator(s) (C) was 0.5 parts.

In Example 10, 0.5 parts of (B) was composed of 0.3 parts of (B1) and 0.2 parts of (B2). In Example 22, 0.5 parts of (C) was composed of 0.4 parts of (C1) and 0.1 parts of (C2).

TABLE 1

| | Radical | | Acid | | Base | |
|---|---|---|---|---|---|---|
| | initiator (A) | | generator (B) | | generator (C) | |
| Example | (A1) | (A2) | (B1) | (B2) | (C1) | (C2) |
| 1 | — | LUCIRIN | B122-1 | — | — | — |
| | | TPO | | | | |
| 2 | — | LUCIRIN | B122-2 | — | — | — |
| | | TPO | | | | |
| 3 | — | LUCIRIN | B122-3 | — | — | — |
| | | TPO | | | | |
| 4 | — | LUCIRIN | B122-4 | — | — | — |
| | | TPO | | | | |
| 5 | — | LUCIRIN | B122-5 | — | — | — |
| | | TPO | | | | |
| 6 | — | BPO | B121-1 | — | — | — |
| 7 | — | BPO | B121-2 | — | — | — |
| 8 | — | BPO | B121-3 | — | — | — |
| 9 | — | BPO | B121-4 | — | — | — |
| 10 | — | LUCIRIN | B122-1 | p-toluene | — | — |
| | | TPO | | sulfonic | | |
| | | | | acid | | |
| | | | | cyclohexyl | | |
| | | | | ester | | |
| 11 | — | BPO | — | — | C122-1 | — |
| 12 | — | BPO | — | — | C122-2 | — |
| 13 | — | BPO | — | — | C122-3 | — |
| 14 | — | BPO | — | — | C122-4 | — |
| 15 | — | LUCIRIN | — | — | C123-1 | — |
| | | TPO | | | | |
| 16 | — | LUCIRIN | — | — | C123-2 | — |
| | | TPO | | | | |
| 17 | — | LUCIRIN | — | — | C123-3 | — |
| | | TPO | | | | |
| 18 | — | LUCIRIN | — | — | C123-4 | — |
| | | TPO | | | | |
| 19 | — | LUCIRIN | — | — | C123-5 | — |
| | | TPO | | | | |
| 20 | — | LUCIRIN | — | — | C123-6 | — |
| | | TPO | | | | |
| 21 | — | LUCIRIN | — | — | C123-7 | — |
| | | TPO | | | | |
| 22 | — | LUCIRIN | — | — | C123-4 | 1-Fmoc-4- |
| | | TPO | | | | piperidone |

### Examples 23 to 28

### Cationic Polymerization

Photosensitive compositions (Q-23) to (Q-28) of the present invention were prepared by kneading cyclohexene oxide (96.5 parts) as an ionic polymerizable compound, together with a radical initiator(s) (A) and acid generator(s) (B) shown in Table 2, using a ball mill at 25° C. for three hours. The amount of a radical initiator (A) was 3 parts and the amount of acid generator(s) (B) was 0.5 parts.

In Example 28, 3 parts of (A) was composed of 2 parts of (A1) and 1 part of (A2), and 0.5 parts of (B) was composed of 0.3 parts of (B1) and 0.2 parts of (B2).

TABLE 2

| | Radical | | Acid | | Base | |
|---|---|---|---|---|---|---|
| | initiator (A) | | generator (B) | | generator (C) | |
| Example | (A1) | (A2) | (B1) | (B2) | (C1) | (C2) |
| 23 | LUCIRIN | — | — | B122-1 | — | — |
| | TPO | | | | | |
| 24 | LUCIRIN | — | — | B122-2 | — | — |
| | TPO | | | | | |
| 25 | LUCIRIN | — | — | B122-3 | — | — |
| | TPO | | | | | |
| 26 | LUCIRIN | — | — | B122-4 | — | — |
| | TPO | | | | | |
| 27 | LUCIRIN | — | — | B122-5 | — | — |
| | TPO | | | | | |
| 28 | LUCIRIN | BPO | B121-1 | p-toluene | — | — |
| | TPO | | | sulfonic | | |
| | | | | acid | | |
| | | | | cyclohexyl | | |
| | | | | ester | | |

### Examples 29 to 34

### Anionic Polymerization

Photosensitive compositions (Q-29) to (Q-34) of the present invention were prepared by kneading the cyclohexene oxide (96.5 parts) as an ionic polymerizable compound, together with radical initiator(s) (A) and base generator(s) (C) shown in Table 3, using a ball mill at 25° C. for three hours. The amount of radical initiator(s) (A) was 3 parts and the amount of base generator(s) (C) was 0.5 parts.

In Example 34, 3 parts of (A) was composed of 2 parts of (A1) and 1 part of (A2), and 0.5 parts of (C) was composed of 0.25 parts of (C1) and 0.25 parts of (C2).

TABLE 3

| | Radical | | Acid | | Base | |
|---|---|---|---|---|---|---|
| | initiator (A) | | generator (B) | | generator (C) | |
| Example | (A1) | (A2) | (B1) | (B2) | (C1) | (C2) |
| 29 | LUCIRIN | — | — | — | — | C122-2 |
| | TPO | | | | | |
| 30 | LUCIRIN | — | — | — | — | C122-3 |
| | TPO | | | | | |
| 31 | LUCIRIN | — | — | — | — | C123-4 |
| | TPO | | | | | |
| 32 | LUCIRIN | — | — | — | — | C123-5 |
| | TPO | | | | | |
| 33 | LUCIRIN | — | — | — | — | C123-6 |
| | TPO | | | | | |
| 34 | LUCIRIN | BPO | — | — | C123-1 | 1-Fmoc-4- |
| | TPO | | | | | piperidone |

### Examples 35 to 46

### Combination [1] of Radical Polymerizable Compounds (D1)

### Example 35

A photosensitive composition (Q-35) of the present invention for hard coating was prepared by blending 4-hydroxybutyl acrylate [“4-HBA” by Osaka Organic Chemical Industry Ltd.] (Da-1) (20 parts), 2-(2-vinyloxy ethoxy)ethyl acrylate [“VEEA” by NIPPON SHOKUBAI CO., LTD.] (Db-1) (9 parts), pentaerythritol triacrylate [“light acrylate PE-3A” by Kyoeisha Chemical Co., Ltd.] (Dc-1) (68 parts), 2,4,6-trimethyl benzoyl-diphenyl-phosphineoxide [“LUCIRIN TPO” by BASF] (A-1) (2.45 parts) as a radical initiator (A), the acid generator (B122-5) (0.3 parts), and amino polyether-modified silicone [“KF-889” by Shin-Etsu Chemical Co., Ltd.] (0.25 parts) as a leveling agent at once, and then uniformly mixing and stirring the mixture with a disperser.

### Example 36

A photosensitive composition (Q-36) of the present invention for hard coating was prepared in the same manner as in Example 35, except that the amounts of the 4-hydroxybutyl acrylate (Da-1), the 2-(2-vinyloxy ethoxy)ethyl acrylate (Db-1), and the pentaerythritol triacrylate (Dc-1) were changed to 35 parts, 35 parts, and 27 parts, respectively.

### Example 37

A photosensitive composition (Q-37) of the present invention for hard coating was prepared in the same manner as in Example 35, except that the amounts of the 4-hydroxybutyl acrylate (Da-1), the 2-(2-vinyloxy ethoxy)ethyl acrylate (Db-1), and the pentaerythritol triacrylate (Dc-1) were changed to 5 parts, 20 parts, and 72 parts, respectively.

### Example 38

A photosensitive composition (Q-38) of the present invention for hard coating was prepared in the same manner as in Example 35, except that the 4-hydroxybutyl acrylate (Da-1) was changed to 2-hydroxyethyl acrylate [“HEA” by Osaka Organic Chemical Industry Ltd.] (Da-2).

### Example 39

A photosensitive composition (Q-39) of the present invention for hard coating was prepared in the same manner as in Example 38, except that the amounts of the 2-hydroxyethyl acrylate (Da-2), the 2-(2-vinyloxy ethoxy)ethyl acrylate (Db-1), and the pentaerythritol triacrylate (Dc-1) were changed to 35 parts, 35 parts, and 27 parts, respectively.

### Example 40

A photosensitive composition (Q-40) of the present invention for hard coating was prepared in the same manner as in Example 38, except that the amounts of the 2-hydroxyethyl acrylate (Da-2), the 2-(2-vinyloxy ethoxy)ethyl acrylate (Db-1), and the pentaerythritol triacrylate (Dc-1) were changed to 5 parts, 20 parts, and 72 parts, respectively.

### Example 41

A photosensitive composition (Q-41) of the present invention for hard coating was prepared in the same manner as in Example 35, except that the 4-hydroxybutyl acrylate (Da-1) was changed to 3-hydroxy-1-adamanthylacrylate [“Adamantate HA” by Idemitsu Kosan Co., Ltd.] (Da-3).

### Example 42

A photosensitive composition (Q-42) of the present invention for hard coating was prepared in the same manner as in Example 35, except that the 4-hydroxybutyl acrylate (Da-1) was changed to 1,4-cyclohexanediol monoacrylate [“Fancryl FA-610A” by Hitachi Chemical Company, Ltd.] (Da-4).

### Example 43

A photosensitive composition (Q-43) of the present invention for hard coating was prepared in the same manner as in Example 35, except that the 4-hydroxybutyl acrylate (Da-1) was changed to a monoacrylate of a polyethylene glycol (Mn: 300) [“Fancryl FA-400A” by Hitachi Chemical Company, Ltd.] (Da-5).

### Example 44

A photosensitive composition (Q-44) of the present invention for hard coating was prepared in the same manner as in Example 35, except that the pentaerythritol triacrylate (Dc-1) was changed to a triacrylate of a pentaerythritol-EO (3.5 mol) adduct [“Neoma EA-301” by Sanyo Chemical Industries, Ltd.] (Dc-2).

### Example 45

A photosensitive composition (Q-45) of the present invention for adhesive agent for hard coating was prepared in the same manner as in Example 35, except that the acid generator (B122-5) was changed to the base generator (C123-4).

### Example 46

A photosensitive composition (Q-46) of the present invention for adhesive agent for hard coating was prepared in the same manner as in Example 36, except that the acid generator (B122-5) was changed to the base generator (C122-4).

### Examples 47 to 52

### Combination [2] of Radical Polymerizable Compounds (D1)

### Example 47

A photosensitive composition (Q-47) of the present invention for hard coating was prepared by blending the pentaerythritol triacrylate (Dc-1) (66.5 parts), 4-acryloyl morpholine [“ACMO” product of KOHJIN Holdings Co., Ltd.] (Dd-1) (28.5 parts), 2,4,6-trimethyl benzoyl-diphenyl-phosphineoxide (A-1) (4.25 parts), the acid generator (B122-5) (0.5 parts), and amino polyether-modified silicone [“KF-889” by Shin-Etsu Chemical Co., Ltd.] (0.24 parts) as a leveling agent at once, and then uniformly mixing and stirring the mixture with a disperser.

### Example 48

A photosensitive composition (Q-48) of the present invention for hard coating was prepared in the same manner as in Example 47, except that the amounts of the pentaerythritol triacrylate (Dc-1) and the 4-acryloyl morpholine (Dd-1) were changed to 84.5 parts and 10.5 parts, respectively.

### Example 49

A photosensitive composition (Q-49) of the present invention for hard coating was prepared in the same manner as in Example 47, except that the amounts of the pentaerythritol triacrylate (Dc-1) and the 4-acryloyl morpholine (Dd-1) were changed to 39.5 parts and 55.5 parts, respectively.

### Example 50

A photosensitive composition (Q-50) of the present invention for hard coating was prepared in the same manner as in Example 47, except that the pentaerythritol triacrylate (Dc-1) was changed to the triacrylate of a pentaerythritol-EO (3.5 mol) adduct (Dc-2).

### Example 51

A photosensitive composition (Q-51) of the present invention for adhesive agent for hard coating was prepared in the same manner as in Example 47, except that the acid generator (B122-5) was changed to the base generator (C123-4).

### Example 52

A photosensitive composition (Q-52) of the present invention for adhesive agent for hard coating was prepared in the same manner as in Example 48, except that the acid generator (B122-5) was changed to the base generator (C122-4).

### Examples 53 to 64

### Combination [3] of Radical Polymerizable Compounds (D1)

### Preparation 21

### [Synthesis of Ester Compound (De-1)]

Trimellitic acid (210 parts), 2-hydroxyethyl acrylate (365.4 parts), toluene (70 parts), p-toluene sulfonic acid (5 parts), and p-methoxyphenol (2 parts) were charged in a flask equipped with a thermometer, an inlet tube for air-nitrogen mixed gas, a stirrer, a water separator, and a reflux condenser. The mixture was heated to 120° C. while being stirred under a stream of air-nitrogen mixed gas to carry out a reaction until the acid value of the reaction solution reached 5 or less. During the reaction, generated water was continuously removed out of the system through the water separator. After the reaction, toluene was evaporated under reduced pressure, and thereby yielding an acryloyl group-containing trimellitic acid ester (De-1).

### Preparation 22

### [Synthesis of Ester Compound (De-2)]

Pyromellitic acid (254 parts), vinyl acetate (344 parts), calcium hydroxide (5 parts), and toluene (70 parts) were charged in a flask equipped with a thermometer, an inlet tube for air-nitrogen mixed gas, a stirrer, a water separator, and a reflux condenser. The mixture was reacted in a 120° C. oil bath under reflux for 12 hours, while being stirred under a stream of air-nitrogen mixed gas. The resulting mixture was cooled and washed with water three times. The toluene was evaporated under reduced pressure, and thereby yielding a vinyl group-containing pyromellitic acid ester (De-2).

### Preparation 23

### [Synthesis of Ester Compound (De-3)]

Trimellitic acid (210 parts), allyl chloride (76.5 parts), toluene (70 parts), and triethyl amine (101 parts) were charged in a flask equipped with a thermometer, an inlet tube for air-nitrogen mixed gas, a stirrer, a water separator, and a reflux condenser. The mixture was stirred at 25° C. for 20 hours under a stream of air-nitrogen mixed gas. After the reaction, the precipitates were removed by filtering and the toluene was evaporated under reduced pressure, and thereby yielding an allyl group-containing trimellitic acid ester (De-3).

### Preparation 24

### [Synthesis of Urethane Acrylate (Df-1)]

Butyl acetate (568 parts), hexamethylene diisocyanate (168 parts), p-methoxyphenol (1.2 parts), and dibutyltin diacetate (1.2 parts) were charged in a flask equipped with a stirrer, an inlet tube for air-nitrogen mixed gas, a cooling tube, and a thermometer. The mixture was heated to 70° C. under a stream of air-nitrogen mixed gas, and then “light acrylate PE3A” [mixture of pentaerythritol diacrylate, pentaerythritol triacrylate, and pentaerythritol tetraacrylate (weight ratio was about 5:60:35) by Kyoeisha Chemical Co., Ltd.] (795 parts) was added dropwise over one hour while the temperature was controlled to 70° C.±10° C. After the dropwise addition, the mixture was reacted at 70° C. for three hours under a stream of air-nitrogen mixed gas. The butyl acetate was evaporated under reduced pressure, and thereby yielding an urethane acrylate (Df-1).

### Preparation 25

### [Synthesis of Urethane Acrylate (Df-2)]

An urethane acrylate (Df-2) was prepared in the same manner as in Preparation 24, except that ““light acrylate PE3A” (795 parts)” was changed to “2-hydroxyethyl acrylate (243.6 parts)”.

### Preparation 26

### [Synthesis of Urethane Acrylate (Df-3)]

An urethane acrylate (Df-3) was prepared in the same manner as in Preparation 24, except that “hexamethylene diisocyanate (168 parts)” and ““light acrylate PE3A” (795 parts)” were changed to “4,4′-dicyclohexyl methanediisocyanate (262 parts)” and ““Neoma DA-600” (mixture of dipentaerythritol pentaacrylate and dipentaerythritol hexaacrylate by Sanyo Chemical Industries, Ltd. (831 parts)”, respectively.

### Preparation 27

### [Synthesis of Urethane Acrylate (Df-4)]

An urethane acrylate (Df-4) was prepared in the same manner as in Preparation 24, except that ““light acrylate PE3A” (795 parts)” and “hexamethylene diisocyanate (168 parts)” were changed to “2-hydroxyethyl acrylate (243.6 parts)” and “isophorone diisocyanate (222 parts)”, respectively.

### Example 53

A photosensitive composition (Q-53) of the present invention for hard coating was prepared by blending the ester compound (De-1) (16 parts), urethane acrylate (Df-1) (67 parts), urethane acrylate (Df-2) (17 parts), 2,4,6-trimethyl benzoyl-diphenyl-phosphineoxide (A-1) (5 parts), acid generator (B122-5) (0.5 parts), and amino polyether-modified silicone [“KF-889” by Shin-Etsu Chemical Co., Ltd.] (1 part) as a leveling agent at once, and then uniformly mixing and stirring the mixture with a disperser.

### Example 54

A photosensitive composition (Q-54) of the present invention for hard coating was prepared in the same manner as in Example 53, except that “urethane acrylate (Df-1)” and “urethane acrylate (Df-2)” were changed to “urethane acrylate (Df-3)” and “urethane acrylate (Df-4)”, respectively.

### Example 55

A photosensitive composition (Q-55) of the present invention for hard coating was prepared in the same manner as in Example 53, except that “ester compound (De-1)” was changed to “ester compound (De-2)”.

### Example 56

A photosensitive composition (Q-56) of the present invention for hard coating was prepared in the same manner as in Example 53, except that “ester compound (De-1)” was changed to “ester compound (De-3)”.

### Example 57

A photosensitive composition (Q-57) of the present invention for hard coating was prepared in the same manner as in Example 53, except that the urethane acrylates (Df-1) and (Df-2) were not used, “Neoma EA-300 [pentaerythritol tetraacrylate by Sanyo Chemical Industries, Ltd.] (60 parts)” was additionally used, and the amount of the ester compound (De-1) was changed to 40 parts.

### Example 58

A photosensitive composition (Q-58) of the present invention for hard coating was prepared in the same manner as in Example 53, except that the acid generator (B122-5) was changed to the base generator (C123-4).

### Example 59

A photosensitive composition (Q-59) of the present invention for negative resist was prepared by kneading the ester compound (De-1) (5 parts), urethane acrylate (Df-1) (33 parts), urethane acrylate (Df-2) (6 parts), “Neoma DA-600” [mixture of dipentaerythritol pentaacrylate and dipentaerythritol hexaacrylate by Sanyo Chemical Industries, Ltd.] (5 parts), ethanone-1-(9-ethyl-6-(2-methyl benzoyl)-9H-carbazole-3-yl]-1-(0-acetyloxime) [IRGACURE OXE 02 by BASF] (A-2) (4.5 parts), 2-hydroxy-2-methyl-1-phenyl-propane-1-on [DAROCUR 1173 by BASF] (A-3) (2 parts), acid generator (B122-5) (0.5 parts), diethylthioxanthone [“Kayacure DETX-S” by Nippon Kayaku Co., Ltd.] (5 parts), CCR-1314H [product of Nippon Kayaku Co., Ltd.] (24 parts), and ethylene glycol monomethyl ether [product of Tokyo Chemical Industry Co., Ltd.] (15 parts), at 25° C. for three hours in a ball mill.

### Example 60

A photosensitive composition (Q-60) of the present invention for negative resist was prepared in the same manner as in Example 59, except that “urethane acrylate (Df-1)” and “urethane acrylate (Df-2)” were changed to “urethane acrylate (Df-3)” and “urethane acrylate (Df-4)”, respectively.

### Example 61

A photosensitive composition (Q-61) of the present invention for negative resist was prepared in the same manner as in Example 59, except that “ester compound (De-1)” was changed to “ester compound (De-2)”.

### Example 62

A photosensitive composition (Q-62) of the present invention for negative resist was prepared in the same manner as in Example 59, except that “ester compound (De-1)” was changed to “ester compound (De-3)”.

### Example 63

A photosensitive composition (Q-63) of the present invention for negative resist was prepared in the same manner as in Example 59, except that the urethane acrylates (Df-1) and (Df-2) were not used.

### Example 64

A photosensitive composition (Q-64) of the present invention for adhesive agent for negative resist was prepared in the same manner as in Example 59, except that the acid generator (B122-5) was changed to the base generator (C122-4).

### Examples 65 to 70

### Combination [4] of Radical Polymerizable Compounds (D1)

### Example 65

A photosensitive composition (Q-65) of the present invention for adhesive agent was prepared by mixing tetrahydrofurfuryl acrylate [“FA-THFA” by Hitachi Chemical Company, Ltd.] (Dg-1) (80 parts), n-stearyl methacrylate [“Light Ester S” by Kyoeisha Chemical Co., Ltd.] (Dh-1) (20 parts), (meth)acryl resin (Mn: 500,000) (E-1) (20 parts) which is a copolymer of (meth)acrylic acid (10 parts), 2-ethyl hexyl(meth)acrylate (9 parts), and vinyl acetate (2 parts), 2,4,6-trimethyl benzoyl-diphenyl-phosphineoxide (A-1) (5 parts), the acid generator (B122-5) (0.5 parts), Irganox 1010 [product of BASF] (1 part) as an antioxidant, and Tinuvin 400 [product of BASF] (0.6 parts) as an ultraviolet absorber at once, and uniformly mixing and stirring the mixture with a disperser.

### Example 66

A photosensitive composition (Q-66) of the present invention for adhesive agent was prepared in the same manner as in Example 65, except that the amount of the tetrahydrofurfuryl acrylate (Dg-1) (80 parts) and the (meth)acryl resin (E-1) (20 parts) were changed to “49 parts” and “22 parts”, respectively, and “n-stearyl methacrylate (Dh-1) (20 parts)” was changed to “isostearyl acrylate [“ISTA” by Osaka Organic Chemical Industry Ltd.] (Dh-2) (20 parts).

### Example 67

A photosensitive composition (Q-67) of the present invention for adhesive agent was prepared in the same manner as in Example 65, except that the amounts of the tetrahydrofurfuryl acrylate (Dg-1) (80 parts), n-stearyl methacrylate (Dh-1) (20 parts), and (meth)acryl resin (E-1) (20 parts) were changed to “15 parts”, “75 parts”, and “10 parts”, respectively.

### Example 68

A photosensitive composition (Q-68) of the present invention for adhesive agent was prepared in the same manner as in Example 65, except that the tetrahydrofurfuryl acrylate (Dg-1) was changed to (2-methyl-2-ethyl-1,3-dioxolan-4-yl)methyl acrylate [“MEDOL-10” by Osaka Organic Chemical Industry Ltd.] (Dg-2).

### Example 69

A photosensitive composition (Q-69) of the present invention for adhesive agent was prepared in the same manner as in Example 65, except that the acid generator (B122-5) was changed to a base generator (C123-4).

### Example 70

A photosensitive composition (Q-70) of the present invention for adhesive agent was prepared in the same manner as in Example 65, except that the acid generator (B122-5) was changed to the base generator (C122-4).

### Comparative Examples 1 and 2

### Radical Polymerization

Photosensitive compositions (Q′-1) and (Q′-2) for comparison were prepared in the same manner as in Example 1, except that a radical initiator (A) shown in Table 4 was used in an amount of 3.5 parts as the radical initiator (A) without using the acid generator (B).

TABLE 4

| | Radical | | Acid | | Base | |
|---|---|---|---|---|---|---|
| Comparative | initiator (A) | | generator (B) | | generator (C) | |
| Example | (A1) | (A2) | (B1) | (B2) | (C1) | (C2) |
| 1 | LUCIRIN | — | — | — | — | — |
| | TPO | | | | | |
| 2 | BPO | — | — | — | — | — |

### Comparative Examples 3 to 8

### Cationic Polymerization

Photosensitive compositions (Q′-3) to (Q′-8) for comparison were prepared in the same manner as in Examples 23 to 28, except that acid generator(s) (B) shown in Table 5 was/were used in an amount of 3.5 parts as the acid generator (B) without using the radical initiator (A).

In Comparative Example 8, 3.5 parts of (B) was composed of 2.5 parts of (B1) and 1 part of (B2).

TABLE 5

| | Radical | | Acid | | Base | |
|---|---|---|---|---|---|---|
| Comparative | initiator (A) | | generator (B) | | generator (C) | |
| Example | (A1) | (A2) | (B1) | (B2) | (C1) | (C2) |
| 3 | — | — | B122-1 | — | — | — |
| 4 | — | — | B122-2 | — | — | — |
| 5 | — | — | B122-3 | — | — | — |
| 6 | — | — | B122-4 | — | — | — |
| 7 | — | — | B122-5 | — | — | — |
| 8 | — | — | B122-1 | p-toluene | — | — |
| | | | | sulfonic | | |
| | | | | acid | | |
| | | | | cyclohexyl | | |
| | | | | ester | | |

### Comparative Examples 9 to 14

### Anionic Polymerization

Photosensitive compositions (Q′-9) to (Q′-14) for comparison were prepared in the same manner as in Examples 29 to 34, except that base generator(s) (C) shown in Table 6 was/were used in an amount of 3.5 parts as the base generator (C) without using the radical initiator (A).

In Comparative Example 14, 3.5 parts of (C) was composed of 2.5 parts of (C1) and 1 part of (C2).

TABLE 6

| | Radical | | Acid | | Base | |
|---|---|---|---|---|---|---|
| Comparative | initiator (A) | | generator (B) | | generator (C) | |
| Example | (A1) | (A2) | (B1) | (B2) | (C1) | (C2) |
| 9 | — | — | — | — | C122-2 | — |
| 10 | — | — | — | — | C122-3 | — |
| 11 | — | — | — | — | C123-4 | — |
| 12 | — | — | — | — | C123-5 | — |
| 13 | — | — | — | — | C123-6 | — |
| 14 | — | — | — | — | C123-4 | 1-Fmoc-4- |
| | | | | | | piperidone |

### Comparative Examples 15 and 16

### Use of Inorganic Particles

Photosensitive compositions (Q′-15) and (Q′-16) for comparison were prepared in the same manner as in Comparative Examples 1 and 2, except that silica sol (“Nanocryl C130” by Nanoresins) (5 parts by weight) was further added.

TABLE 7

| | Radical | | Acid | | Base | |
|---|---|---|---|---|---|---|
| Comparative | initiator (A) | | generator (B) | | generator (C) | |
| Example | (A1) | (A2) | (B1) | (B2) | (C1) | (C2) |
| 15 | LUCIRIN | — | — | — | — | — |
| | TPO | | | | | |
| 16 | BPO | — | — | — | — | — |

Regarding the compounds shown in Tables 1 to 7, LUCIRIN TPO as (A121) was a product of BASF; 1-Fmoc-piperidone as (C21) was a product of ALDRICH; BPO (benzoyl peroxide) as (A21) was “NYPER BW” by NOF CORPORATION; and cyclohexyl p-toluenesulfonate as (B21) was a product of Tokyo Chemical Industry Co., Ltd.

### [Adhesion]

Each of the photosensitive compositions prepared in Examples 1 to 58, 65 to 70 and Comparative Examples 1 to 17 was applied to a surface-treated PET (polyethylene terephthalate) film having a thickness of 100 μm [COSMOSHINE A4300 by Toyobo Co., Ltd., the same PET films were used in below evaluations] and to a PMMA (poly methyl methacrylate) film having a thickness of 125 μm [ACRYPLEN HBS010P by MITSUBISHI RAYON CO., LTD.] using an applicator to form a 20-μm thick coating. The applied coating was exposed to light using a belt conveyor-type UV irradiator (“ECS-151U” by EYE GRAPHICS CO., LTD., the same apparatus was used in the below evaluations). The 365 nm exposure dose was 150 mJ/cm².

The adhesions of the cured coatings on the PET film and PMMA film were evaluated by the cross-cut cellophane tape peel test in conformity with JIS K-5400.

### [Transparency (Transmittance and Haze)]

Each of the photosensitive compositions prepared in Examples 1 to 58, 65 to 70 and Comparative Examples 1 to 17 was applied to the same surface-treated PET film having a thickness of 100 μm as the above using an applicator to form a 20-μm thick coating. The applied coating was exposed to light using the belt conveyor-type UV irradiator. The 365 nm exposure dose was 150 mJ/cm².

The transmittance and haze of the cured coating were measured using a total light transmittance measuring device [trade name: “haze-garddual” product of BYK gardner] in conformity with JIS-K7105. Both values were shown in %.

### [Pencil Hardness]

Each of the photosensitive compositions prepared in Examples 1 to 58 and Comparative Examples 1 to 17 was applied to the same surface-treated PET film having a thickness of 100 μm as above using an applicator to form a 20-μm thick coating. The applied coating was exposed to light using the belt conveyor-type UV irradiator. The 365 nm exposure dose was 150 mJ/cm².

The pencil hardness of the cured coating was measured in conformity with JIS K-5400.

### [Scratch Resistance]

Each of the photosensitive compositions prepared in Examples 1 to 58 and Comparative Examples 1 to 17 was applied to the same surface-treated PET film having a thickness of 100 μm as the above using an applicator to form a 20-μm thick coating. The applied coating was exposed to light using the belt conveyor-type UV irradiator. The 365 nm exposure dose was 150 mJ/cm².

The cured coating was rubbed to and fro 30 times at a load of 250 g/cm² using steel wool #0000, and the appearance thereof was visually evaluated according to the following criteria:

++: No scratches were observed.

+: Several scratches were observed.

−: Many scratches and white turbidness were observed on the surface.

### [Heat Resistance]

Each of the photosensitive compositions prepared in Examples 1 to 34, 65 to 70, and Comparative Examples 1 to 17 was applied to the same surface-treated PET film having a thickness of 100 μm as the above using an applicator to form a 20-μm thick coating. The applied coating was exposed to light using the belt conveyor-type UV irradiator. The 365 nm exposure dose was 150 mJ/cm².

The cured coating was placed in a forced convection constant temperature drying oven (DKN302 by Yamato Scientific Co., Ltd.) at 85° C. and the temperature was controlled for 100 or 300 hours.

The resulting resin film was observed visually and using a profile microscope (ultra-deep profile measuring microscope, VK-8550, by KEYENCE CORPORATION) at 50-times magnification to evaluate according to the following criteria:

++: No appearance change or color change was observed after the temperature control.

+: No appearance change was observed, but color change was observed after the temperature control.

−: Appearance or color changes were not observed visually, but were observed by the microscope after the temperature control.

−−: Changes were visually observed after the temperature control.

[Curability]

Each of the photosensitive compositions prepared in Examples 1 to 58, 65 to 70, and Comparative Examples 1 to 17 was applied to the same surface-treated PET film having a thickness of 100 μm as the above using an applicator to form a 20- or 80-μm thick coating. The two irradiators shown below were used for light irradiation.

(1) The above belt conveyor-type UV irradiator

The 365 nm exposure dose was 150 mJ/cm².

(2) A spot-type LED irradiator (“RX FireFlex” by Phoseon Technology)

The exposure dose was 150 mJ/cm².

The cured coating was touched with fingers and scratched with nails immediately after exposure to light for evaluation of cure state according to the following criteria:

++: No tuck or scratch by nails was observed on the surface.

+: No tuck was observed, but scratches by nails were observed on the surface.

±: Tucks and scratches by nails were observed on the surface.

−: The coating did not cure.

### [Yellowing Resistance]

Each of the photosensitive compositions prepared in Examples 1 to 58, 65 to 70, and Comparative Examples 1 to 17 was applied to the same surface-treated PET film having a thickness of 100 μm as the above using an applicator to form a 20-μm thick coating. The applied coating was exposed to light using the belt conveyor-type UV irradiator. The 365 nm exposure dose was 10,000 mJ/cm². The appearance of the coating was visually observed and evaluated according to the following criteria:

++: No yellowing was observed.

+: Slight yellowing was observed when placed on white paper.

±: Yellowing was observed under a fluorescent lamp.

−: Significant yellowing was observed.

### [Storage Stability]

Each of the photosensitive compositions prepared in Examples 1 to 58, 65 to 70, and Comparative Examples 1 to 17 was left to stand at 40° C. for one week. The appearance thereof was visually observed and evaluated according to the following criteria:

++: No viscosity change or color change was observed after the temperature control.

+: No viscosity change was observed but slight color change was observed after the temperature control.

±: The viscosity and color changes were observed after the temperature control.

−: The composition was completely solidified and the color change was observed after the temperature control.

### [Coating Film Developing Property]

Each of the photosensitive compositions for negative resist prepared in Examples 59 to 64 was applied to the same surface-treated PET film having a thickness of 100 μm as the above using an applicator to form a 20-μm thick coating. The applied coating was prebaked at 80° C. for three minutes under reduced pressure (4 kPa) to dry the solvent. A 15 μm-wide linear mask was set over the film and the film was exposed to light using the belt conveyor-type UV irradiator. The 365 nm exposure doses were 75 mJ/cm² and 150 mJ/cm².

The film after the exposure was immersed in a 1% NaCO₂ aqueous solution for 100 seconds. The resulting film was sprayed with ion-exchanged water for alkaline developing. The film was then postbaked at 80° C. for three minutes under reduced pressure (4 kPa).

The developed coating film was visually observed through an optical microscope to evaluate the developing property based on the patterned area (%) according to the following criteria:

++: Patterned area without defects was 98% or more.

+: Patterned area without defects was 95% or more and less than 98%.

±: Patterned area without defects was 90% or more and less than 95%.

−: Patterned area without defects was less than 90%, namely, patterning was failed.

Tables 8 to 12 show the results of these evaluations.

TABLE 8

| | | | | | | | | | Curability | | | |
|---|---|---|---|---|---|---|---|---|---|---|---|---|
| | | | | | | | | | Irradiation | Irradiation | | |
| | Adhesion | | Transmittance | Haze | Pencil | Scratch | Heat resistance | | device: ECS- | device: RX | Yellowing | Storage |
| Example | PET | PMMA | (%) | (%) | hardness | resistance | 100 hrs | 300 hrs | 151U | FireFlex | resistance | stability |
| 1 | 100/100 | 99/100 | 92 | 0.2 | 2 H | ++ | + | + | ++ | ++ | ++ | ++ |
| 2 | 100/100 | 99/100 | 91 | 0.3 | 2 H | ++ | + | + | ++ | ++ | ++ | ++ |
| 3 | 100/100 | 99/100 | 92 | 0.1 | 2 H | ++ | + | + | ++ | ++ | ++ | ++ |
| 4 | 99/100 | 95/100 | 90 | 0.2 | 2 H | ++ | + | + | ++ | + | ++ | ++ |
| 5 | 100/100 | 99/100 | 93 | 0.1 | 2 H | ++ | + | + | ++ | ++ | ++ | ++ |
| 6 | 100/100 | 98/100 | 91 | 0.3 | 2 H | ++ | + | + | ++ | + | ++ | + |
| 7 | 100/100 | 99/100 | 92 | 0.4 | 2 H | ++ | + | + | ++ | + | ++ | + |
| 8 | 99/100 | 99/100 | 93 | 0.1 | 2 H | ++ | + | + | ++ | + | ++ | + |
| 9 | 100/100 | 98/100 | 91 | 0.1 | 2 H | + | + | + | + | + | ++ | + |
| 10 | 100/100 | 95/100 | 90 | 0.2 | 2 H | ++ | + | + | ++ | ++ | ++ | ++ |
| 11 | 91/100 | 90/100 | 91 | 0.1 | 2 H | + | + | + | + | + | + | + |
| 12 | 96/100 | 98/100 | 92 | 0.3 | 2 H | + | + | + | + | + | + | + |
| 13 | 95/100 | 98/100 | 92 | 0.2 | 2 H | + | + | + | + | + | + | + |
| 14 | 100/100 | 99/100 | 92 | 0.1 | 2 H | ++ | + | + | ++ | + | + | + |
| 15 | 100/100 | 99/100 | 93 | 0.1 | 2 H | ++ | + | + | ++ | + | + | ++ |
| 16 | 100/100 | 99/100 | 91 | 0.2 | 2 H | ++ | + | + | ++ | + | + | ++ |
| 17 | 99/100 | 95/100 | 90 | 0.3 | 2 H | ++ | + | + | ++ | + | + | ++ |
| 18 | 100/100 | 98/100 | 90 | 0.3 | 2 H | ++ | + | + | ++ | ++ | + | ++ |
| 19 | 100/100 | 99/100 | 91 | 0.2 | 2 H | ++ | + | + | ++ | ++ | + | ++ |
| 20 | 99/100 | 99/100 | 93 | 0.4 | 2 H | ++ | + | + | ++ | ++ | + | ++ |
| 21 | 100/100 | 98/100 | 90 | 0.2 | 2 H | ++ | + | + | ++ | + | + | ++ |
| 22 | 100/100 | 95/100 | 91 | 0.3 | 2 H | ++ | + | + | ++ | ++ | + | ++ |
| 23 | 91/100 | 90/100 | 92 | 0.1 | 2 H | ++ | + | + | ++ | ++ | ++ | ++ |
| 24 | 96/100 | 98/100 | 92 | 0.2 | 2 H | ++ | + | + | ++ | ++ | ++ | ++ |
| 25 | 95/100 | 98/100 | 91 | 0.1 | 2 H | ++ | + | + | ++ | ++ | ++ | ++ |
| 26 | 99/100 | 95/100 | 91 | 0.2 | 2 H | ++ | + | + | ++ | + | ++ | ++ |
| 27 | 100/100 | 99/100 | 91 | 0.1 | 2 H | ++ | + | + | ++ | + | ++ | ++ |
| 28 | 100/100 | 98/100 | 91 | 0.1 | 2 H | ++ | + | + | ++ | ++ | ++ | + |
| 29 | 100/100 | 99/100 | 90 | 0.2 | 2 H | ++ | + | + | + | + | + | ++ |
| 30 | 99/100 | 99/100 | 93 | 0.3 | 2 H | + | + | + | + | + | + | ++ |
| 31 | 100/100 | 98/100 | 90 | 0.1 | 2 H | ++ | + | + | ++ | ++ | + | ++ |
| 32 | 91/100 | 90/100 | 91 | 0.2 | 2 H | ++ | + | + | ++ | ++ | + | ++ |
| 33 | 96/100 | 98/100 | 92 | 0.1 | 2 H | ++ | + | + | ++ | + | + | ++ |
| 34 | 95/100 | 98/100 | 90 | 0.2 | 2 H | ++ | + | + | ++ | ++ | + | + |

TABLE 9

| | | | | | | | Curability | | | |
|---|---|---|---|---|---|---|---|---|---|---|
| | | | | | | | Irradiation | Irradiation | | |
| | Adhesion | | Transmittance | Haze | Pencil | Scratch | device: ECS- | device: RX | Yellowing | Storage |
| Example | PET | PMMA | (%) | (%) | hardness | resistance | 151U | FireFlex | resistance | stability |
| 35 | 100/100 | 99/100 | 92 | 0.2 | 3 H | ++ | ++ | ++ | ++ | ++ |
| 36 | 100/100 | 99/100 | 92 | 0.2 | 3 H | ++ | ++ | ++ | ++ | ++ |
| 37 | 99/100 | 96/100 | 92 | 0.2 | 3 H | ++ | ++ | ++ | ++ | ++ |
| 38 | 100/100 | 96/100 | 92 | 0.2 | 3 H | ++ | ++ | + | ++ | ++ |
| 39 | 99/100 | 95/100 | 92 | 0.2 | 3 H | ++ | ++ | ++ | ++ | ++ |
| 40 | 100/100 | 95/100 | 92 | 0.2 | 3 H | ++ | ++ | + | ++ | ++ |
| 41 | 90/100 | 92/100 | 92 | 0.1 | 3 H | ++ | ++ | + | ++ | ++ |
| 42 | 91/100 | 91/100 | 92 | 0.2 | 3 H | ++ | ++ | + | ++ | ++ |
| 43 | 96/100 | 91/100 | 92 | 0.2 | 3 H | ++ | + | + | ++ | ++ |
| 44 | 95/100 | 90/100 | 92 | 0.1 | 3 H | ++ | + | + | ++ | ++ |
| 45 | 100/100 | 99/100 | 92 | 0.2 | 3 H | ++ | ++ | ++ | + | ++ |
| 46 | 100/100 | 98/100 | 90 | 0.2 | 3 H | ++ | ++ | ++ | + | ++ |
| 47 | 100/100 | 99/100 | 90 | 0.2 | 3 H | ++ | ++ | + | ++ | ++ |
| 48 | 97/100 | 99/100 | 90 | 0.2 | 3 H | ++ | ++ | + | ++ | ++ |
| 49 | 99/100 | 99/100 | 90 | 0.2 | 3 H | ++ | + | + | ++ | ++ |
| 50 | 96/100 | 99/100 | 90 | 0.2 | 3 H | ++ | + | + | ++ | ++ |
| 51 | 99/100 | 99/100 | 90 | 0.2 | 3 H | ++ | ++ | + | + | ++ |
| 52 | 97/100 | 99/100 | 90 | 0.2 | 3 H | ++ | ++ | + | + | ++ |
| 53 | 99/100 | 100/100 | 94 | 0.1 | 5 H | ++ | ++ | ++ | ++ | ++ |
| 54 | 100/100 | 99/100 | 92 | 0.2 | 4 H | ++ | ++ | ++ | ++ | ++ |
| 55 | 100/100 | 99/100 | 90 | 0.3 | 5 H | ++ | ++ | ++ | ++ | ++ |
| 56 | 100/100 | 99/100 | 94 | 0.1 | 5 H | ++ | ++ | ++ | ++ | ++ |
| 57 | 95/100 | 95/100 | 92 | 0.2 | 4 H | ++ | + | + | ++ | ++ |
| 58 | 99/100 | 99/100 | 94 | 0.1 | 5 H | ++ | ++ | ++ | + | ++ |

TABLE 10

| | | | | | | | Curability | | | |
|---|---|---|---|---|---|---|---|---|---|---|
| | | | | | | | Irradiation | Irradiation | | |
| | Adhesion | | Transmittance | Haze | Heat resistance | | device: ECS- | device: RX | Yellowing | Storage |
| Example | PET | PMMA | (%) | (%) | 100 hrs | 300 hrs | 151U | FireFlex | resistance | stability |
| 65 | 100/100 | 100/100 | 95 | 0.1 | ++ | ++ | ++ | + | ++ | ++ |
| 66 | 100/100 | 100/100 | 95 | 0.1 | ++ | ++ | ++ | ++ | ++ | ++ |
| 67 | 100/100 | 100/100 | 94 | 0.1 | ++ | ++ | ++ | ++ | ++ | ++ |
| 68 | 100/100 | 100/100 | 94 | 0.1 | ++ | ++ | + | + | ++ | ++ |
| 69 | 100/100 | 100/100 | 94 | 0.1 | ++ | ++ | ++ | ++ | + | ++ |
| 70 | 100/100 | 100/100 | 93 | 0.1 | ++ | ++ | ++ | ++ | + | ++ |

TABLE 11

Coating film developing property

| | Exposure dose: | Exposure dose: |
|---|---|---|
| Example | 75 mJ/cm² | 150 mJ/cm² |
| 59 | ± | + |
| 60 | ± | ± |
| 61 | ± | ± |
| 62 | + | ++ |
| 63 | ++ | ++ |
| 64 | ++ | ++ |

TABLE 12

| | | | | | | | | | Curability | | | |
|---|---|---|---|---|---|---|---|---|---|---|---|---|
| | | | | | | | | | Irradiation | Irradiation | | |
| Comparative | Adhesion | | Transmittance | Haze | Pencil | Scratch | Heat resistance | | device: ECS- | device: RX | Yellowing | Storage |
| Example | PET | PMMA | (%) | (%) | hardness | resistance | 100 hrs | 300 hrs | 151U | FireFlex | resistance | stability |
| 1 | 0/100 | 0/100 | 85 | 1.1 | B | − | − | − | ± | − | + | ++ |
| 2 | 2/100 | 0/100 | 83 | 1.4 | B | − | − | − | ± | − | + | ± |
| 3 | 0/100 | 3/100 | 82 | 1.5 | B | − | − | − | ± | − | + | ++ |
| 4 | 0/100 | 0/100 | 80 | 1.3 | B | − | − | − | ± | − | + | ++ |
| 5 | 2/100 | 5/100 | 84 | 1.2 | B | − | − | − | ± | − | + | ++ |
| 6 | 0/100 | 0/100 | 85 | 1.1 | B | − | − | − | ± | − | + | ++ |
| 7 | 6/100 | 10/100 | 85 | 1.0 | B | − | ± | − | ± | − | + | ++ |
| 8 | 0/100 | 0/100 | 86 | 1.0 | B | − | ± | − | ± | − | + | ++ |
| 9 | 1/100 | 0/100 | 88 | 1.1 | B | − | − | − | − | − | ± | ++ |
| 10 | 0/100 | 0/100 | 87 | 1.6 | B | − | − | − | − | − | ± | ++ |
| 11 | 0/100 | 0/100 | 80 | 1.5 | B | − | ± | − | ± | − | ± | ++ |
| 12 | 2/100 | 10/100 | 86 | 1.3 | B | − | − | − | ± | − | ± | ++ |
| 13 | 0/100 | 0/100 | 88 | 1.3 | B | − | − | − | ± | − | ± | ++ |
| 14 | 0/100 | 0/100 | 81 | 1.2 | B | − | − | − | ± | − | ± | ++ |
| 15 | 0/100 | 0/100 | 77 | 2.4 | B | + | − | − | ++ | ++ | + | + |
| 16 | 4/100 | 4/100 | 81 | 1.6 | B | − | − | − | ++ | ++ | + | ± |

### INDUSTRIAL APPLICABILITY

The photosensitive composition of the present invention is excellent in scratch resistance and curable with a small amount of energy to form a transparent cured article, and therefore is remarkably useful as a buffer layer between an image display unit and a front panel of an image displays device (e.g. cathode ray tube, liquid crystal display, plasma display, electroluminescence display, touch panel, and flat panel display), a coating material, an ink, an adhesive agents, and a composition for forming a resist pattern.

1. A photosensitive composition, comprising the following the (1), (2), and (3) components:
(1) a radical initiator (A);
(2) an acid generator (B) and/or a base generator (C); and
(3) a polymerizable substance (D),
wherein at least one of the radical initiator (A), the acid generator (B), and the base generator (C) are to generate an active species (H) on exposure to active rays, the active species (H) reacting with the radical initiator (A), the acid generator (B), or the base generator (C) to generate another active species (I), the active species (I) initiating polymerization of the polymerizable substance (D),
the active species (H) or (I) is an acid or a base, and
the photosensitive composition contains substantially no colorants, metal oxide powder, or metallic powder.

2. The photosensitive composition according to claim 1,
wherein the radical initiator (A) is a radical initiator (A1) that generates radicals on exposure to active rays or a radical initiator (A2) that generates radicals on exposure to an acid and/or a base,
the acid generator (B) is an acid generator (B1) that generates an acid on exposure to active rays or an acid generator (B2) that generates an acid on exposure to at least one species selected from the group consisting of radicals, acids, and bases,
the base generator (C) is a base generator (C1) that generates a base on exposure to active rays or a base generator (C2) that generates a base on exposure to at least one species selected from the group consisting of radicals, acids, and bases, and
the photosensitive composition comprises (A1), (A2), (B1), (B2), (C1), or (C2) in any one of the following combinations (1) to (4):
(1) (A1) and at least one of (B2) and (C2);
(2) (B1), (A2), and optionally (C2);
(3) (C1), (A2), and optionally (B2); and
(4) a combination of two or more of the above (1) to (3).

3. A photosensitive composition, comprising
a polymerizable substance (D), and
a radical initiator (A), an acid generator (B), and
a base generator (C) in any one of the following combinations (1) to (4):
(1) a radical initiator (A1) that generates radicals on exposure to active rays; and at least one of an acid generator (B2) and a base generator (C2), the acid generator (B2) generating an acid on exposure to at least one species selected from the group consisting of radicals, acids, and bases, and the base generator (C2) generating a base on exposure to at least one species selected from the group consisting of radicals, acids, and bases;
(2) an acid generator (B1) that generates an acid on exposure to active rays; a radical initiator (A2) that generates radicals on exposure to an acid and/or a base; and optionally a base generator (C2) that generates a base on exposure to at least one species selected from the group consisting of radicals, acids, and bases;
(3) a base generator (C1) that generates a base on exposure to active rays; the radical initiator (A2) that generates radicals on exposure to an acid and/or a base; and optionally an acid generator (B2) that generates an acid on exposure to at least one species selected from the group consisting of radicals, acids, and bases; and
(4) a combination of two or more of the above (1) to (3),
wherein the photosensitive composition contains substantially no colorants, metal oxide powder, or metallic powder.

4. The photosensitive composition according to claim 2,
wherein the radical initiator (A1) or the radical initiator (A2) is at least one radical initiator selected from the group consisting of acylphosphine oxide derivative-based polymerization initiators (A121), α-aminoacetophenone derivative-based polymerization initiators (A122), benzyl ketal derivative-based polymerization initiators (A123), α-hydroxyacetophenone derivative-based polymerization initiators (A124), benzoin derivative-based polymerization initiators (A125), oxime ester derivative-based polymerization initiators (A126), titanocene derivative-based polymerization initiators (A127), organic peroxide-based polymerization initiators (A21), and azo-based polymerization initiators (A22).

5. The photosensitive composition according to claim 2,
wherein the acid generator (B 1) or the acid generator (B2) is at least one acid generator selected from the group consisting of sulfonium salt derivatives (B121), iodonium salt derivatives (B122), sulfonic acid ester derivatives (B21), acetic acid ester derivatives (B22), and phosphonic acid esters (B23).

6. The photosensitive composition according to claim 5,
wherein the sulfonium salt derivative (B121) is a compound represented by the following formula (1) or (2): 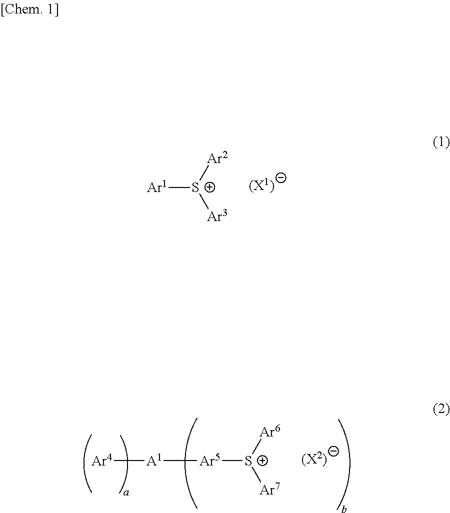
wherein A¹ is a divalent or trivalent group represented by any one of the following formulas (3) to (10); Ar¹ to Ar⁷ are individually an aromatic hydrocarbon or heterocyclic group with at least one benzene ring, and are optionally substituted by at least one atom or substituent selected from the group consisting of halogens, and C1-C20 acyl, C1-C20 alkyl, C1-C20 alkoxy, C1-C20 alkylthio, C1-C20 alkylsilyl, nitro, carboxyl, hydroxyl, mercapto, amino, cyano, phenyl, naphthyl, phenoxy, and phenylthio groups; Ar¹ to Ar⁴, Ar⁶, and Ar⁷ are each a monovalent group, and Ar⁵ is a divalent group; (X¹)⁻ and (X²)⁻ are each a negative ion; and a is an integer of 0 to 2, b is an integer of 1 to 3, and (a+b) is 2 or 3 and is the same as the valence of A¹: 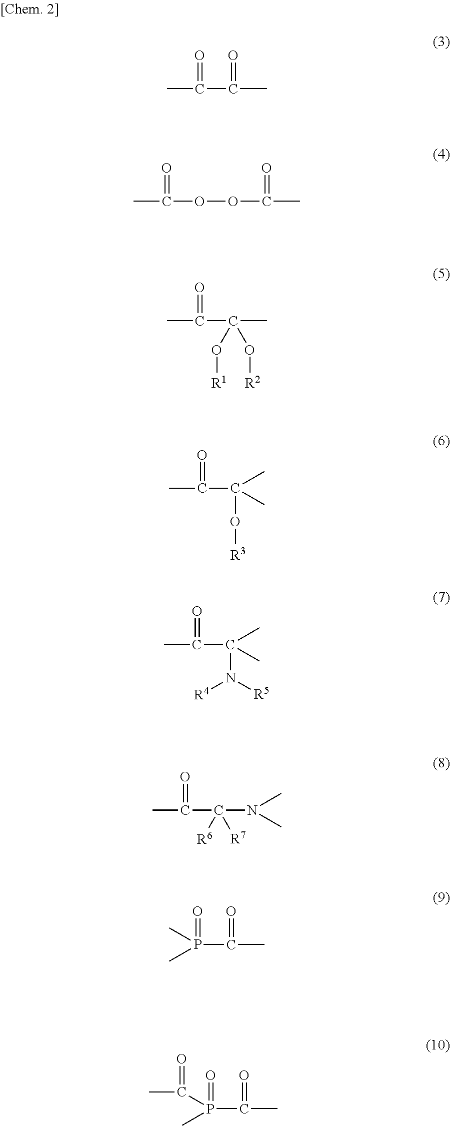
wherein R¹ to R⁷ are individually a hydrogen, a C1-C20 alkyl group, or a phenyl group optionally substituted by at least one atom or substituent selected from the group consisting of halogens, and C1-C20 acyl, C1-C20 alkyl, amino, cyano, phenyl, naphthyl, phenoxy, and phenylthio groups; and R¹, R⁴, and R⁶ may optionally link to R², R⁵, and R⁷, respectively, to form a ring structure.

7. The photosensitive composition according to claim 5,
wherein the iodonium salt derivative (B122) is a compound represented by the following formula (15) or (16): 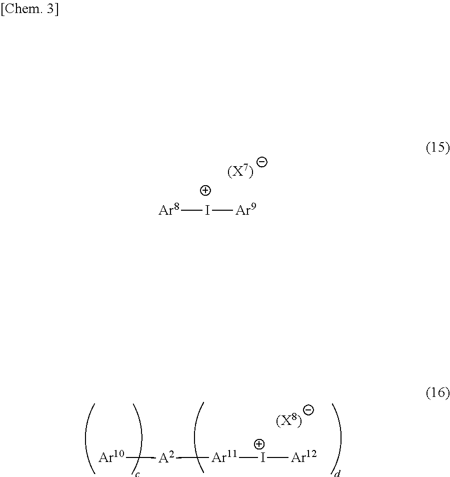
wherein A² is a divalent or trivalent group represented by any one of the formulas (3) to (10); Ar⁸ to Ar¹² are individually an aromatic hydrocarbon or heterocyclic group with at least one benzene ring, and are optionally substituted by at least one atom or substituent selected from the group consisting of halogens, and C1-C20 acyl, C1-C20 alkyl, C1-C20 alkoxy, C1-C20 alkylthio, C1-C20 alkylsilyl, nitro, carboxyl, hydroxyl, mercapto, amino, cyano, phenyl, naphthyl, phenoxy, and phenylthio groups; Ar⁸ to Ar¹⁰ and Ar¹² are each a monovalent group, and Ar¹¹ is a divalent group; (X⁷)⁻ and (X⁸)⁻ are each a negative ion; and c is an integer of 0 to 2, d is an integer of 1 to 3, and (c+d) is 2 or 3 and is the same as the valence of A².

8. The photosensitive composition according to claim 2,
wherein the base generator (C1) or the base generator (C2) is at least one base generator selected from the group consisting of oxime derivatives (C121), quaternary ammonium salt derivatives (C122), quaternary amidine salt derivatives (C123), and carbamate derivatives (C21).

9. The photosensitive composition according to claim 2,
wherein the base generator (C1) or the base generator (C2) is a compound represented by any one of the following formulas (21) to (23): 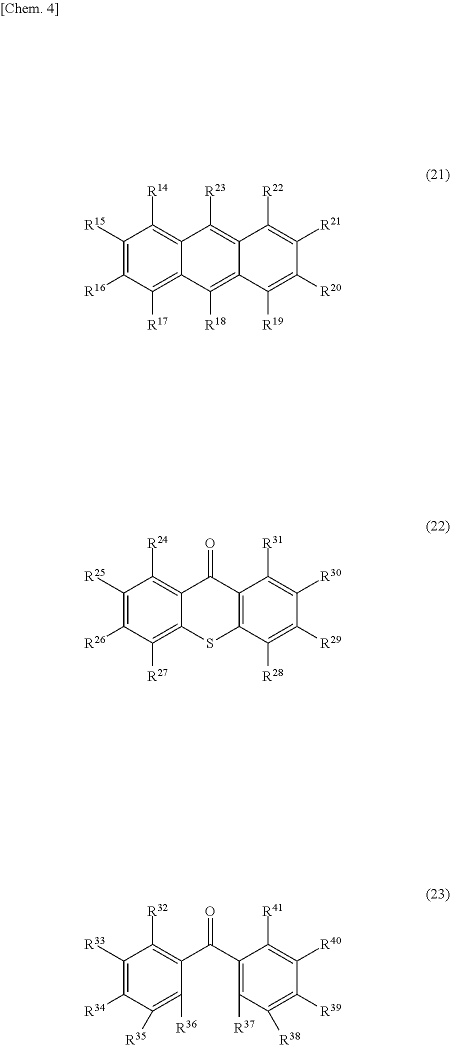
wherein R¹⁴ to R⁴¹ are individually an atom or substituent selected from the group consisting of hydrogen, halogens, C1-C20 acyl, C1-C20 alkyl, C1-C20 alkoxy, C1-C20 alkylthio, C1-C20 alkylsilyl, nitro, carboxyl, hydroxyl, mercapto, amino, cyano, phenyl, and naphthyl groups, substituents represented by the following formula (24), and substituents represented by the following formula (25); at least one of R¹⁴ to R²³ is a substituent represented by the formula (24) or (25); at least one of R²⁴ to R³¹ is a substituent represented by the formula (24) or (25); and at least one of R³² to R⁴¹ is a substituent represented by the formula (24) or (25): 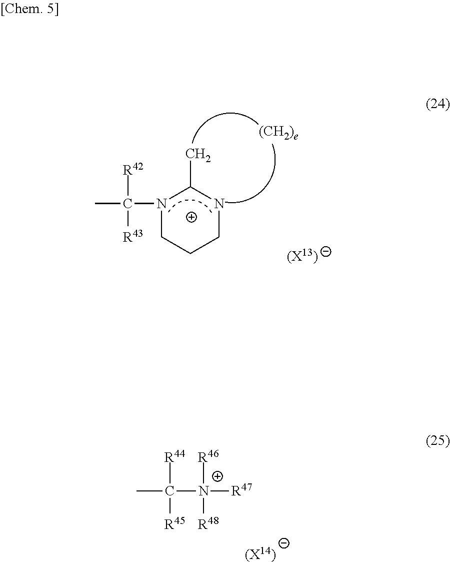
wherein R⁴² to R⁴⁵ are each a hydrogen or C1-C20 alkyl group; R⁴⁶ to R⁴⁸ are each a C1-C20 alkyl group optionally substituted by a hydroxyl group; (X¹³)⁻ and (X¹⁴)⁻ are each a negative ion; and e is an integer of 2 to 4.

10. The photosensitive composition according to claim 1,
wherein the polymerizable substance (D) is a radical polymerizable compound (D1) and/or an ionic polymerizable compound (D2).

11. The photosensitive composition according to claim 10,
wherein the radical polymerizable compound (D1) contains at least one compound selected from the group consisting of acryl amide compounds, (meth)acrylate compounds, aromatic vinyl compounds, and vinyl ether compounds.

12. The photosensitive composition according to claim 10,
wherein the radical polymerizable compound (D1) is any one of the compounds shown by the following combinations [1] to [4]:
[1] a combination of a compound that contains a monofunctional (meth)acrylate (Da) containing one or more hydroxyl groups, a monofunctional (meth)acrylate (Db) containing a vinyl ether group and/or an allyl ether and containing no hydroxyl groups, and a (meth)acrylate (Dc) with three or more functional groups, containing one or more hydroxyl groups;
[2] a compound that contains a (meth)acrylate (Dc) with three or more functional groups, containing one or more hydroxyl groups, and 4-(meth)acryloyl morpholine (Dd);
[3] a compound that contains at least one ester compound (De) selected from the group consisting of a phthalic acid ester, a trimellitic acid ester, and a pyromellitic acid ester, all of which contain an ethylenically unsaturated bond-containing group; and optionally an urethane and/or urea group-containing (meth)acrylate (Df); and
[4] a compound that contains a (meth)acrylate (Dg) having a cyclic ether skeleton; and a C1-C24 alkyl group-containing alkyl(meth)acrylate (Dh), provided that the photosensitive composition contains a (meth)acryl resin (E) which is a copolymer of at least two kinds of radical polymerizable monomers.

13. The photosensitive composition according to claim 10,
wherein the ionic polymerizable compound (D2) is a C3-C20 epoxy compound (D21) and/or a C4-C20 oxetane compound (D22).

14. The photosensitive composition according to claim 1,
wherein the amount of the radical initiator (A) is 0.05 to 30% by weight of the polymerizable substance (D), and the amount of the acid generator (B) and/or base generator (C) in terms of the total amount of the (B) and (C) is 0.05 to 30% by weight of the polymerizable substance (D).

15. The photosensitive composition according to claim 1,
wherein the composition is intended to be used for a buffer layer between an image display unit and a front panel of an image display device selected from the group consisting of a cathode ray tube, a liquid crystal display, a plasma display, an electroluminescence display, a touch panel, and a flat panel display; a coating material; an ink; an adhesive agent; and a composition for forming a resist pattern.

16. A cured article obtainable by curing the photosensitive composition according to claim 1 on exposure to active rays.

17. A method for producing a cured article which is cured on exposure to active rays, comprising the steps of:
polymerizing a polymerizable substance (D) on exposure to active rays in the presence of a radical initiator (A) and at least one of an acid generator (B) and a base generator (C) but in the substantial absence of colorants, metal oxide powder and metallic powder,
wherein, in the polymerization, at least one of the radical initiator (A), acid generator (B), and base generator (C) generates an active species (H) on exposure to active rays, the active species (H) reacts with the radical initiator (A), acid generator (B), or base generator (C) to generate another active species (I), the active species (I) initiates the polymerization of the polymerizable substance (D), wherein the active species (H) or (I) is an acid or a base.
